(19) United States
(12) Patent Application Publication
(10) Pub. No.: US 2016/0021874 A1
(43) Pub. Date: Jan. 28, 2016

(54) METHODS AND DEVICES FOR ACHIEVING HIGH SURVIVALS OF LIVING CELLS AFTER FREEZING OR VITRIFICATION

(71) Applicant: University of Tennessee Research Foundation, Knoxville, TN (US)

(72) Inventors: Peter Mazur, Oak Ridge, TN (US); Bo Jin, Dalian (CN); Frederick W. Kleinhans, Indianapolis, IN (US)

(21) Appl. No.: 14/808,588

(22) Filed: Jul. 24, 2015

Related U.S. Application Data
(60) Provisional application No. 62/028,581, filed on Jul. 24, 2014.

(51) Int. Cl. A01N 1/02

(52) U.S. Cl. CPC A01N 1/0242; A01N 1/0284; A01N 1/0252

(57) ABSTRACT

Methods are described for warming a sample that contains a cell or tissue, wherein the method heats the sample at a warming rate of at least about 1×10⁶° C. and/or that increase the functional survival of the cell or tissue upon warming. The warming can be done using a laser that emits infrared wavelength light. Also described are systems and devices for rapid warming and cooling of samples.

### RELATED APPLICATIONS

The presently disclosed subject matter is based on and claims the benefit of U.S. Provisional Patent Application Ser. No. 62/028,581, filed Jul. 24, 2014; the disclosure of which is incorporated herein by reference in its entirety.

### GOVERNMENT INTEREST

This invention was made with government support under Grant No. R01-OD011201 awarded by the National Institutes of Health. The government has certain rights in the invention.

### TECHNICAL FIELD

The presently disclosed subject matter relates to methods of warming a sample comprising a cell or tissue (e.g., a sample comprising a cell or tissue that has been frozen or vitrified) and to methods of increasing the functional survival of a cell or tissue (e.g., a cell or tissue that has been frozen or vitrified) upon warming. The methods involve rapid warming of the cell, tissue and/or sample thereof, e.g., heating at a rate of at least about 1×10⁶° C./minute. The presently disclosed subject matter also relates to an apparatus for the rapid cooling and warming of a sample comprising a cell or tissue.

### BACKGROUND

In vitro fertilization (IVF) and embryo transfer has found increasing use in methods of treating human infertility. The agricultural industry is also increasingly making use of assisted reproduction techniques, e.g., to improve the genetic quality of livestock. Additionally, there is a need to preserve the germplasm of endangered species and to maintain mutant and transgenic lines of mice and other mammals. Accordingly, there is an accelerating interest in the cryopreservation of oocytes and pre-implantation embryos. There is also an interest in the cryopreservation of non-reproductive cells and tissues.

Generally, the future survival of a cryopreserved cell requires that no more than a minimal amount of small crystals of ice form inside the cell. One way to avoid intracellular ice is to vitrify cells: i.e., to convert cell water to a glass rather than to ice. To accomplish this, high cooling rates and high concentrations of glass-inducing solutes have been used. However, the high solute concentrations themselves can be osmotically and/or chemically damaging.

Accordingly, there is an ongoing need for additional techniques and systems for the cryopreservation of biological samples, e.g., that can result in increased functionality of the preserved samples upon warming. There is also a need for techniques and systems that are less labor intensive and/or that are more reproducible.

### SUMMARY

In some embodiments, the presently disclosed subject matter provides a method for warming a sample comprising a cell or tissue. In some embodiments, the method comprises: (a) providing a sample comprising a cell or tissue in need of warming, wherein the sample further comprises a medium; and (b) heating the sample at a warming rate of at least about 1×10⁶ degrees Celsius (° C.) per minute, whereby the cell or tissue survives after warming. In some embodiments, the cell or tissue is dehydrated.

In some embodiments, the medium is a vitrification medium. In some embodiments, the medium has a molality of from about 2 to about 7. In some embodiments, the molality is about 2.

In some embodiments, the warming rate is at least about 1×10⁷° C. per minute. In some embodiments, the medium comprises one or more solutes and the one or more solutes do not permeate the cell or tissue.

In some embodiments, the heating is accomplished by exposing the sample to a laser. In some embodiments, the medium comprises a component that absorbs at a wavelength emitted by the laser. In some embodiments, the component comprises carbon black particles and the wavelength of the laser is about 1064 nm.

In some embodiments, the cell or tissue is selected from the group comprising an oocyte, an embryo, a sperm cell, an islet of Langerhans, an ovary cell, an ovary slice, a Drosophila embryo, a zebrafish embryo, a zebrafish stage II oocyte, a zebrafish stage III oocyte, a marine mollusk, a cornea, a cornea cell, and a marine echinoderm. In some embodiments, the cell or tissue has a thickness or diameter of about 500 microns or smaller.

In some embodiments, providing a sample comprising a cell or tissue in need of warming comprises providing a sample wherein the sample is frozen and/or vitrified at a cooling rate of about 10,000° C. per minute or more.

In some embodiments, the presently disclosed subject matter provides a method for increasing the functional survival of a cell or tissue upon warming. In some embodiments, the method comprises: (a) providing a sample comprising a cell or tissue in need of warming, wherein the sample further comprises a medium; and (b) heating the sample at a warming rate that increases the functional survival of the cell or tissue as compared to a cell or tissue in a sample that is not heated at the warming rate. In some embodiments, the cell or tissue is dehydrated. In some embodiments, the warming rate is at least about 1×10⁶ degrees Celsius (° C.) per minute.

In some embodiments, the medium is a vitrification medium. In some embodiments, the medium has a molality ranging from about 2 to about 7. In some embodiments, the molality is about 2.

In some embodiments, the warming rate is at least about 1×10⁷ degrees Celsius (° C.) per minute. In some embodiments, the medium comprises one or more solutes and the one or more solutes do not permeate the cell or tissue.

In some embodiments, the heating is accomplished by exposing the sample to a laser. In some embodiments, the medium includes a component that absorbs at a wavelength emitted by the laser. In some embodiments, the component comprises carbon black particles and the wavelength of the laser is 1064 nm.

In some embodiments, the cell or tissue is selected from the group comprising an oocyte, an embryo, a sperm cell, an islet of Langerhans, an ovary cell, an ovary slice, a Drosophila embryo, a zebrafish embryo, a zebrafish stage II oocyte, a zebrafish stage III oocyte, a marine mollusk, a cornea, a cornea cell, and a marine echinoderm. In some embodiments, the cell or tissue has a thickness or diameter of about 500 microns or smaller. In some embodiments, the sample is frozen and/or vitrified at a cooling rate of about 10,000° C. per minute or more.

In some embodiments, the presently disclosed subject matter provides a jig for a system for the rapid cooling and warming of a sample comprising a cell or tissue, wherein the sample further comprises a medium. In some embodiments, the jig comprises: (a) a holder adapted for movement between a first position and a second position; (b) a shaft connected to the holder, the shaft having a first end and a second end, wherein the first end connects the shaft to the holder and wherein the second end of the shaft is adapted to receive a sample comprising a cell or tissue, wherein the sample further comprises a medium; (c) a trigger adapted for activation when the holder is moved from the first position to the second position; and (d) a switch operable to activate a heating source when the trigger is activated. In some embodiments, the trigger further comprises a cover operable to isolate a sample from a cooling source upon movement of the holder from the first position to the second position. In some embodiments, the cover is adapted for movement between a first cover position and a second cover position and is operably connected to the trigger such that the trigger actuates movement of the cover between the first cover position and the second cover position.

In some embodiments, the presently disclosed subject matter provides a system for the rapid cooling and warming of a sample comprising a cell or tissue, wherein the sample further comprises a medium. In some embodiments, the system comprises: (a) a jig comprising (i) a holder adapted for movement between a first position and a second position; (ii) a shaft connected to the holder, the shaft having a first end and a second end, wherein the first end connects the shaft to the holder and wherein the second end of the shaft is adapted to receive a sample comprising a cell or tissue, wherein the sample further comprises a medium; (iii) a trigger adapted for activation when the holder is moved from the first position to the second position; and (iv) a switch operable to activate a heating source when the trigger is activated; (b) a heating source; and (c) a cooling source; wherein the heating and cooling sources are operably arranged with respect to the jig such that the sample can be contacted by the cooling source at the first position of the holder of the jig and the sample can be contacted by the heating source at the second position of the holder of jig.

In some embodiments, the heating source is a laser. In some embodiments, the laser has a wavelength of 1064 nm.

In some embodiments, the cooling source is a reservoir adapted to receive a cooling medium. In some embodiments, the cooling medium is liquid nitrogen. In some embodiments, the cooling source further comprises a cover adapted for movement between a first cover position and a second cover position, wherein the cover is operably connected to the trigger wherein the trigger actuates movement of the cover between the first cover position and the second cover position.

Accordingly, it is an object of the presently disclosed subject matter to provide methods and apparatus for warming samples and/or for increasing the functional survival of a cell or tissue upon warming.

An object of the presently disclosed subject matter having been stated hereinabove, and which is achieved in whole or in part by the presently disclosed subject matter, other objects will become evident as the description proceeds herein below.

### BRIEF DESCRIPTION OF THE DRAWINGS

FIG. 1 is a photograph of a top view of a sample blade B of an exemplary sample manipulation device for sample vitrification and/or freezing. Sample blade B is equipped with a 50 micron (μm) copper-constantan thermocouple C. The junction of the thermocouple is immersed in a 0.1 microliter (μl) droplet A of a sample, which can contain a cell or tissue in a liquid medium. The thermocouple is held in place by a small dab of nail polish D.

FIG. 2 is a front view of a system for rewarming a sample. The illustration shows a laser with a Cryo Jig positioned inside the working chamber of the laser.

FIG. 3A is a perspective view of a Cryo Jig (CJ) used to manipulate a sample during rapid cooling in liquid nitrogen (LN₂) or LN₂ vapor and ultra-rapid warming by a laser pulse. The Cryo Jig is shown in a “closed” position, where the sample at end 1 of sample manipulation device shaft 2 is isolated from cooling medium chamber 5 by cover slide 6. A representative length for the base of cooling medium chamber 5 is 13 centimeters.

FIG. 3B is a perspective view of the Cryo Jig described for FIG. 3A where the Cryo Jig is in the “open” position, wherein end 1 is inside cooling medium chamber 5.

FIG. 4 is a front view of a Cryo Jig similar to that described for FIGS. 3A and 3B mounted on optional x-y stage 14.

FIG. 5 is a graph showing the osmotic/morphological survival percentage (%) of mouse oocytes as a function of the total molality of solutes in the modified ethylene glycol-acetamide-Ficoll-sucrose (EAFS) vitrification solution in which they were suspended during cooling at 69,000 degrees Celsius per minute (° C./min) and warming at 1.0×10⁷° C./min (•), 3.0×10⁶° C./min (□), and 1.2×10⁵° C./min (∘).

FIG. 6 is a graph showing the survival percentage (%) of mouse oocytes subjected to rapid cooling and laser assisted ultra-rapid warming as a function of the molality of sucrose in the external solutions. The closed circles give the survivals when the warming was laser-accelerated to produce a rate of 1.0×10⁷ degrees Celsius per minute (° C./min). The open circles give the survivals when the samples were not exposed to the laser, and the warming rate was 1.2×10⁵° C./min, i.e, about 100-fold slower than the rate for laser warming.

FIG. 7 is a graph showing the osmotic/morphological survival percentage (%) of mouse oocytes as a function of the molality of Ficoll 70 and two concentrations of sucrose in the modified ethylene glycol-acetamide-Ficoll-sucrose (EAFS) vitrification solutions in which they were suspended during cooling at 69,000 degrees Celsius per minute (° C./min) and warming at either 1.0×10⁷° C./min by laser (closed symbols) or at 1.2×10⁵° C./min without the laser (open symbols). The sucrose molalities were 0.16 molal (circles) or 0.72 molal (squares).

FIG. 8A is a graph showing the thermal response of oocytes when subjected to a laser-induced warming rate of 2×10⁶ degrees Celsius per minute (° C./min) determined using finite element analysis. The graph contains four curves: The uppermost thicker solid black line is the applied warming ramp curve; i.e., the laser-driven temperature of the ethylene glycol-acetamide-Ficoll-sucrose (EAFS) solution plus India Ink surrounding the oocyte. The remaining three curves show the response temperature at the surface of the oocyte proper (at r=37.5 microns (μm); thinner solid black line), at the half mass radius (r=29.8 μm; dashed line), and at the center of the oocyte (r=0; solid grey line). At an applied warming rate (WR) of 2×10⁶° C./min, the oocyte lags the applied ramp slightly but the slope of the oocyte warming curve is the same as the applied rate.

FIG. 8B is a graph showing the thermal response of oocytes when subjected to a laser-induced warming rate of 1×10⁷ degrees Celsius per minute (° C./min) determined using finite element analysis. The graph contains four curves: The uppermost, thicker solid black line is the applied warming ramp curve; i.e., the laser-driven temperature of the ethylene glycol-acetamide-Ficoll-sucrose (EAFS) solution plus India Ink surrounding the oocyte. The remaining three curves show the response temperature at the surface of the oocyte proper (at r=37.5 micron (μm); thinner solid black line), at the half mass radius (r=29.8 μm; dashed line), and at the center of the oocyte (r=0; solid grey line). At an applied warming rate of 1×10⁷° C./min, the oocyte temperature lags, and the slope of the oocyte warming curve is slightly less (0.75×10⁷° C./min between −100° C. and −30° C.) than the applied rate of 1.0×10⁷° C./min.

FIG. 9 is a graph showing the morphological and functional percentage (%) survival (squares and circles, respectively) of oocytes and embryos vitrified in a solution without a permeating solute and warmed with a laser (closed symbols) or without a laser (open symbols). The oocyte and embryo developmental stages are as indicated on the x axis.

FIG. 10 is a graph showing the percentage (%) survival of oocytes with and without laser warming (closed and open symbols, respectively) as a function of the mass of cell water to total mass after two minutes in a vitrification solution. Cells were either suspended in about 0.3× ethylene glycol-acetamide-Ficoll-sucrose (EAFS) vitrification solution (circles) or in 0.72 or 1.0 molal sucrose (without permeating solutes; squares). The percentage survivals of the cells suspended in approximately 0.3× EAFS are based on morphology. The percentage survivals of the cells suspended in the solution without permeating solute are based on function, i.e., the ability to undergo in vitro fertilization (IVF) and develop to 2-cell embryos.

### DETAILED DESCRIPTION

The presently disclosed subject matter will now be described more fully. The presently disclosed subject matter can, however, be embodied in different forms and should not be construed as limited to the embodiments set forth herein below and in the accompanying Examples. Rather, these embodiments are provided so that this disclosure will be thorough and complete, and will fully convey the scope of the embodiments to those skilled in the art.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

### I. Definitions

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a”, “an”, and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

Unless otherwise indicated, all numbers expressing quantities of temperature, rate, time, molality, survival percentage, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value is meant to encompass variations of in one example ±20% or ±10%, in another example ±5%, in another example ±1%, and in still another example ±0.1% from the specified amount, as such variations are appropriate to perform the disclosed methods.

The term “cryopreservation” refers to a process wherein cells, tissues or other substances are preserved in the living state by being cooled to sub-zero temperatures.

The term “cryoprotectant” refers to a fluid or solution used to replace extracellular and/or intracellular water prior to cryopreservation and/or vitrification. Cryoprotectants can include one or more components such as, but not limited to, sterile water, HEPES, sodium bicarbonate, sodium hydroxide, sodium chloride, potassium chloride, calcium chloride, potassium phosphate, magnesium sulfate, dextrose, maltose, sucrose, Ficoll, saline, sodium lactate solution, glycol solutions, formamide, dimethyl formamide, glycerophosphate, diols (e.g., 1,2-propanediol, 1,3-propanediol, or 2,3-butanediol), sodium pyruvate, gentamicin sulfate, alanine, choline, xylose, glycine, glycoproteins, and human serum albumin. Cryoprotectants can be used to miminize cell damage during the cryopreservation and/or vitrification process. In some embodiments, the cryoprotectant is such that it does not form ice in liquid nitrogen. Cryoprotectants can be permeating or non-permeating. Permeating cryoprotectants are typically small molecules that permeate the cell membrane and can form hydrogen bonds to water molecules to prevent ice crystallization. Permeating cryoprotectants include, but are not limited to, ethylene glycol (EG), dimethyl sulfoxide (DMSO) and glycerol. Non-permeating cryprotectants remain extracellular and can include, but are not limited to, trehalose and sucrose, agarose, dextrans, glucose, hydroxyethylstarch, inositol, lactose, methyl glucose, polyvinylpyrrolidione, and sorbitol.

As used herein, the terms “freeze” or “freezing” refer to the cooling of a liquid to a solid state, which can include ice crystal formation.

As used herein, the term “vitrification” refers to the rapid cooling of a liquid medium in the absence of ice crystal formation. For example, a sample containing a cell or tissue can be rapidly cooled to a very low temperature (e.g., −196° C.) such that the water content forms a glass-like state without crystallizing.

The term “oocyte” refers to an unfertilized female reproductive cell. The term “oocyte” as used herein can be synonymous with “egg”.

The term “embryo” as used herein can refer to a fertilized egg during the stage of development lasting from between the time of the first division to two cells to about 5 days after fertilization.

The term “blastocyst” refers to a fertilized egg during the stage of development lasting from about 5 days after fertilization up to implantation in the uterus.

The terms “dehydrate” and “dehydrated” as used herein can refer to the at least partial removal of intracellular water from a cell or cells. Agents that facilitate dehydration of intra-cytoplasmic water include, but are not limited to, sucrose, dextrose, trehalose, lactose, raffinose, and the like.

As used herein, the term “warming” can refer to thawing a sample, melting a sample, or to combinations thereof. The term “heating” can be used synonymously with “warming.”

The term “survival” can refer to either or both of morphological survival and functional survival. By “morphological survival” is meant membrane intactness of a biological cell or group of cells, osmotic responsiveness, and/or morphological normality. Determination of “functional survival” can vary from cell/tissue type to cell/tissue type, as would be understood by one of ordinary skill in the art. In some embodiments, “functional survival” can refer to the ability of an oocyte to be fertilized in vitro and develop to expanded blastocysts in culture. In some embodiments, “functional survival” can refer to the ability of an embryo (e.g., a 2-cell embryo) to develop into an expanded blastocyst in vitro.

II. Methods for Warming a Sample and/or Increasing the Functional Survival of a Sample

Various processes are known for the cryopreservation of biological samples, such as oocytes. Conventional cryopreservation involves a slow freeze method, in which the outside medium progressively freezes while the water in the cells remains supercooled. Because it is supercooled, its chemical potential is higher than that of the extracellular ice/solution and, as a consequence, the cells dehydrate if cooled slowly enough to below −100° C. and do not freeze internally. Commonly, the cells are cooled to and stored in liquid nitrogen (LN₂) at a temperature of −196° C. At that extremely low temperature, cellular activity is essentially halted and cells can remain viable indefinitely. However, this is not always the case, because the cooling rate may not be low enough to prevent the formation of lethal intracellular ice.

Vitrification can reduce the occurrence of intracellular ice crystals, potentially increasing sample survival and functionality after thaw. Thus vitrification can be a desired route for the cryopreservation of animal embryos, oocytes and other cells or tissues of medical, genetic and agricultural importance. Current thinking is that successful vitrification requires cells to be suspended in and permeated by high concentrations of protective solutes (e.g., that the cells need to be suspended in a medium containing at least about 6 molal solutes) and that they be cooled at very high rates (e.g., at >40,000° C./min) to below −100° C. The presence of permeating solutes in the vitrification solution (VS) is also believed to be important.

In contrast to these currently held beliefs, according to some aspects of the presently disclosed subject matter, it was found that if mouse oocytes, as a representative cell population, are suspended in media that produce considerable osmotic dehydration before freezing/vitrification, and/or are subsequently warmed at an ultra-high rate (e.g., at least 1,000,000° C./min or 10,000,000° C./min), nearly 100% survive, even when cooled relatively slowly (e.g., as low as 10,000° C./min or lower) and/or when the concentration of solutes in the medium is only about one third that of the concentration of a standard vitrification medium used in the field. The high rates of warming can be achieved, for example, by use of a laser pulse, e.g., an infrared laser pulse. In some embodiments, the warming rate of the presently disclosed methods is about 3.5 to 100 times faster than the warming rates previously used in the field (e.g., about 1.2×10⁵° C./min). Further, the presence of a permeating solute in the VS is not essential.

In some embodiments, the presently disclosed subject matter provides a method of warming a sample in need thereof. The method can comprise: providing a sample comprising a cell or tissue in need of warming, wherein the sample further comprises a medium; and heating the sample at a warming rate of at least about 1×10⁶° C./minute, whereby the cell or tissue survives after warming. In some embodiments, the warming rate is at least about 1×10⁷° C./minute.

In some embodiments, the presently disclosed subject matter provides a method for increasing the functional survival of a cell or tissue upon warming. In some embodiments, the method comprising: providing a sample comprising a cell or tissue in need of warming, wherein the sample further comprises a medium; and heating the sample at a warming rate that increases the functional survival of the cell or tissue as compared to a cell or tissue in a sample that is not heated at the warming rate. In some embodiments, the warming rate is at least about 1×10⁶° C./minute. In some embodiments, the warming rate is at least about 1×10⁷° C./minute. Thus, in some embodiments, the cell or tissue has increased functional survival compared to a sample heated at a rate of 1.2×10⁶° C./min or less.

In some embodiments, providing the sample comprises freezing and/or vitrifying the sample. In some embodiments, the sample is frozen and/or vitrified at a cooling rate of about 10,000° C. per minute or more. In some embodiments, the cell or tissue is dehydrated.

In some embodiments, the sample medium is a vitrification medium. In some embodiments, the medium has a molality of between about 0.5 and about 7. In some embodiments, the molality is between about 1.5 and about 7 (i.e., about 1.5, about 1.75, about 2, about 2.25, about 2.5, about 2.75, about 3, about 3.25, about 3.5, about 3.75, about 4, about 4.25, about 4.5, about 4.75, about 5, about 5.25, about 5.5, about 5.75, about 6, about 6.25, about 6.5, about 6.75, or about 7). In some embodiments, the molality is between about 2 and about 7. In some embodiments, the molality is between about 1.5 and about 5.5. In some embodiments, the molality is between about 1.8 and about 2.5. In some embodiments, the molality is about 2.

The vitrification medium can include one or more solutes that permeate the cell or tissue, one or more solutes that do not permeate the cell or tissue, or a combination thereof. Permeating solutes can include, but are not limited to, ethylene glycol (EG) and acetamide. Non-permeating solutes can include, but are not limited to, sucrose, Ficoll, and sodium chloride (NaCl). In some embodiments, the vitrification medium is free of a solute that permeates the cell or tissue.

In some embodiments, the vitrification medium is EAFS 10/10 or a modified version thereof. EAFS is a solution developed by Pedro et al. (see Pedro et al., Cryobiology, 35 (1997), 150-158) where E, A, F, and S refer to EG, acetamide, Ficoll, and sucrose, respectively. The total molality of a standard EAFS is 7.38 molal, of which 6.5 molal is permeating (EG and acetamide), and the remainder are non-permeating. In some embodiments, the medium is a diluted standard vitrification medium. In some embodiments, the medium is diluted to a molality of about half of the standard or less. In some embodiments, the medium is diluted to a molality of about one third of the standard.

In some embodiments, the heating is accomplished by exposing the sample to a laser (e.g., a laser pulse). However, any heating source that can provide the desired warming rate falls within the scope of the presently disclosed subject matter. In some embodiments, the laser emits infrared (IR) light. In some embodiments, the laser emits light at 1064 nm. Such a wavelength can be emitted by, for example, a Nd:YAG laser. However, 1064 nm and other IR wavelengths (e.g., 2100 nm) in general are merely representative wavelengths at which the presently disclosed subject matter can be practiced.

In some embodiments of the presently disclosed subject matter, the sample to be warmed does not comprise or is substantially or even completely free of cells that either naturally possess a laser-absorbing chromophore and/or cells into which the chromophore can be injected. In some embodiments, the laser emits light at a wavelength, such as a near IR wavelength like 1064 nm, that is absorbed poorly (e.g., about 10% or less, about 5% or less, or about 3.5%) by water and/or by the contents of the cell or tissue of the sample. In some embodiments, the medium includes and/or a component is added to the medium that absorbs at the wavelength of the laser. Thus, rather than directly heating the cell or tissue with the laser, a component in the medium absorbs the light from the laser and gives off heat, thereby indirectly heating the cell or tissue, e.g., by heating the medium surrounding the cell or tissue.

In some embodiments, the component that absorbs at the wavelength of the laser comprises carbon black or another suitable black body material. In some embodiments, the carbon black is present in the form of particles.

Suitable particles can have a diameter ranging from between about 0.1 μm to about 1 μm. Such particles can be obtained, for example, from commercially available black inks (e.g., India inks), which contain suspensions of carbon black particles. However, any suitable source of carbon black particles can be used.

In some embodiments, a black ink (e.g., India ink) is added to the medium. The concentration of ink added can be adjusted to allow most of the IR energy to pass completely through the sample. This can provide even sample heating from front to back. In some embodiments, the medium comprises between about 0.2% v/v and about 0.5% v/v India ink. It is estimated that ink-free medium samples absorb about 9% of the incident energy from 1064 nm wavelength radiation. A sample comprising about 0.25% v/v India ink can absorb about 25% of the remaining energy, yielding a total of about 30% absorption. In some embodiments, the medium absorbing component comprises carbon black particles and the wavelength of the laser is 1064 nm.

Alternatively, in some embodiments, the cell or tissue can absorb the wavelength emitted by the laser. For example, wavelengths longer than 1064 nm (e.g., 2100 nm) can be used to warm water (e.g., cytoplasmic water). Such wavelengths can be obtained from, for example, Ho:YAG lasers. Thus, in some embodiments, the cell or tissue can be directly warmed by a laser pulse. In some embodiments, the medium is free of added absorbing components (such as carbon black particles) typically not present in cryopreservation solutions. For embodiments in which the cell or tissue can absorb the laser radiation, cell, tissue and/or sample size can be selected and/or varied such that a significant percentage (e.g., about 50%) of the laser energy incident on the sample passes through the sample. Sample transmission can be calculated using the Beer-Lambert law. If the sample absorbs the majority of the laser energy, uneven heating of the sample can occur, with the leading surface of the sample being preferentially heated compared to the surface located opposite to the laser radiation.

In some embodiments, the cell or tissue can absorb the wavelength emitted by the laser, and an absorbing component (e.g., carbon black) is still added to the medium. Thus, in some embodiments, “mixed” warming can occur, wherein some of the heating is direct heating of the cell or tissue and some heating is indirect.

While mouse oocytes and embryos are used as representative test cells for the samples of the Examples described below, any suitable cell or tissue can be included in sample of the presently disclosed subject matter. For example, both mouse and human oocytes can be used, as it is expected that the presently disclosed methods could yield improvements in survival rates of these cells compared to conventional cryopreservation or vitrification procedures. The presently disclosed methods can also be used for samples comprising cell types that can not currently be fully preserved via conventional procedures. Such cell types include, but are not limited to, oocytes and embryos of non-mammalian vertebrates, such as zebrafish and amphibians; embryos of invertebrates, such as mollusks, echinoderms, and many insects; and some mammalian cells and thin tissues, such as, granulocytes, corneas, and islets of Langerhans.

Cell or tissue size can be selected to reduce uneven heating (e.g., due to possible differences in warming rates between outer portions of the cell and the interior portions of the cell in methods involving indirect heating). Generally, the cell or tissue to be warmed according to the presently disclosed method has a thickness or diameter of about 1000 μm or less, of about 750 μm or less, or of about 500 μm or less. In some embodiments, the cell or tissue has a thickness or diameter of about 500 μm or less. In some embodiments, wherein the sample is directly heated, the sample can have thickness or diameter of about 330 μm or less. In some embodiments, the cell or tissue is selected from the group comprising, but not limited to, an oocyte, an embryo, a sperm cell, an islet of Langerhans, an ovary cell, optionally an ovary slice, a Drosophila embryo, a zebrafish embryo, a zebrafish stage II or stage III oocyte, a marine mollusk, a cornea or cornea cell, and a marine echinoderm. Mouse eggs, for example, have a diameter of about 75 μm; corneas have a thickness of about 500 μm; an islet of Langerhans has a diameter of about 200-400 μm; ovarian and other tissue slices can have a thickness of 500 μm or less; 15 hour Drosophila embryos can be about 200×500 μm; zebrafish embryos can have a diameter of about 750 μm; and marine mollusks and echinoderms can have a diameter of about 60-120 μm.

### III. Systems and Devices

In some embodiments, the presently disclosed subject matter provides a device adapted for use in methods of rapid warming and/or cooling of a sample, e.g., samples comprising a cell or tissue, and in systems for the same. Such a device is referred to herein as a “Cryo Jig” or “jig”. More particularly, the Cryo Jig is a device for quickly transferring a sample to and from a compartment at a very low temperature (e.g., a LN₂ container or reservoir) to a position where the sample can be loaded (e.g., prior to cooling) and/or warmed (e.g., after cooling). For example, the position where the sample is warmed can be in the path of a laser beam.

The samples of the presently disclosed devices comprise a cell or tissue in a liquid medium. Suitable cells and tissues and sample sizes are described elsewhere herein. The sample can be placed on a sample manipulation device attached to, or attachable to, the presently disclosed jig. Any suitable sample manipulation device can be used. For example, suitable sample manipulation devices can be those typically used in the cryopreservation and/or vitrification of oocytes and embryos for IVF. The sample manipulation device can be a blade or stick-type device. For instance, the sample manipulation device can comprise a flexible plastic blade with a width of about 0.7 mm and a thickness of about 0.1 mm. The blade can comprise polypropylene or another suitable polymer. The flexible blade can be attached at one end to a wider and/or less flexible shaft, which can also comprise a polymer. In some embodiments, the blade-type device can be a CRYOTOP® (Kitazato BioPharma Co. Ltd., Fuji, Japan) or a similar device. Other suitable sample manipulation devices include pipette-style devices comprising a hollow tube into which the sample is sucked prior to preservation or a loop-style device. Such devices include the CRYOTIP® (Irvine Scientific Sales Company, Inc., Santa Ana, California, United States of America) and CryoLoop™ (Hampton Research Corporation, Aliso Viejo, Calif., United States of America).

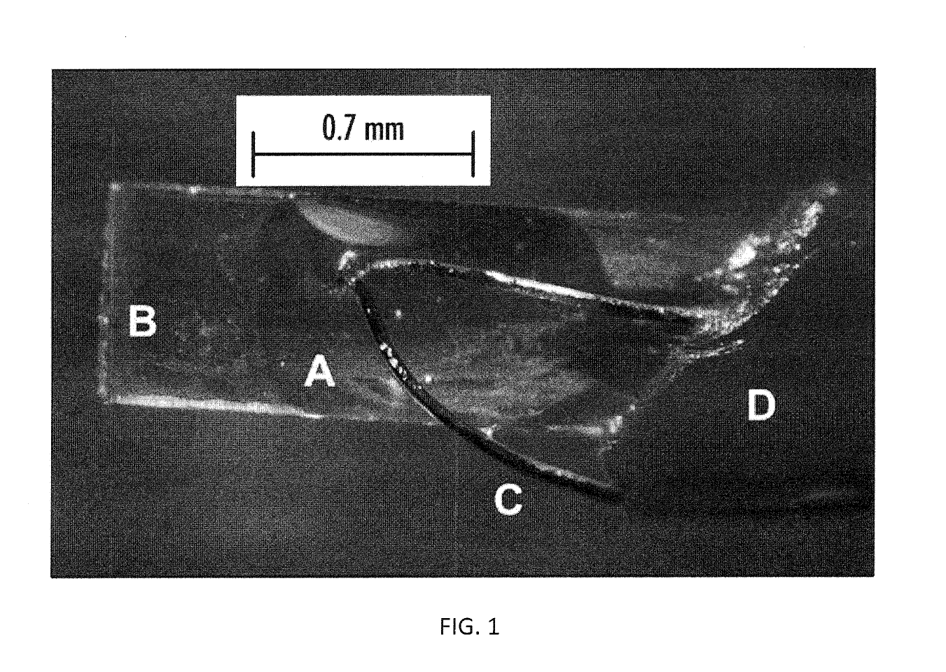

Liquid samples can be placed near one end of the flexible plastic blade or other sample manipulation device prior to cryopreservation. FIG. 1 illustrates the blade end of a blade-style sample manipulation device with a sample drop A near one end of blade B. The sample manipulation device of FIG. 1 is also equipped with thermocouple C attached via nail polish drop D. The thermocouple can be used to measure the warming rate of drop A. However, the thermocouple and nail polish drop are optional. The warming rate can also be calculated mathematically, as described more fully in the Examples below.

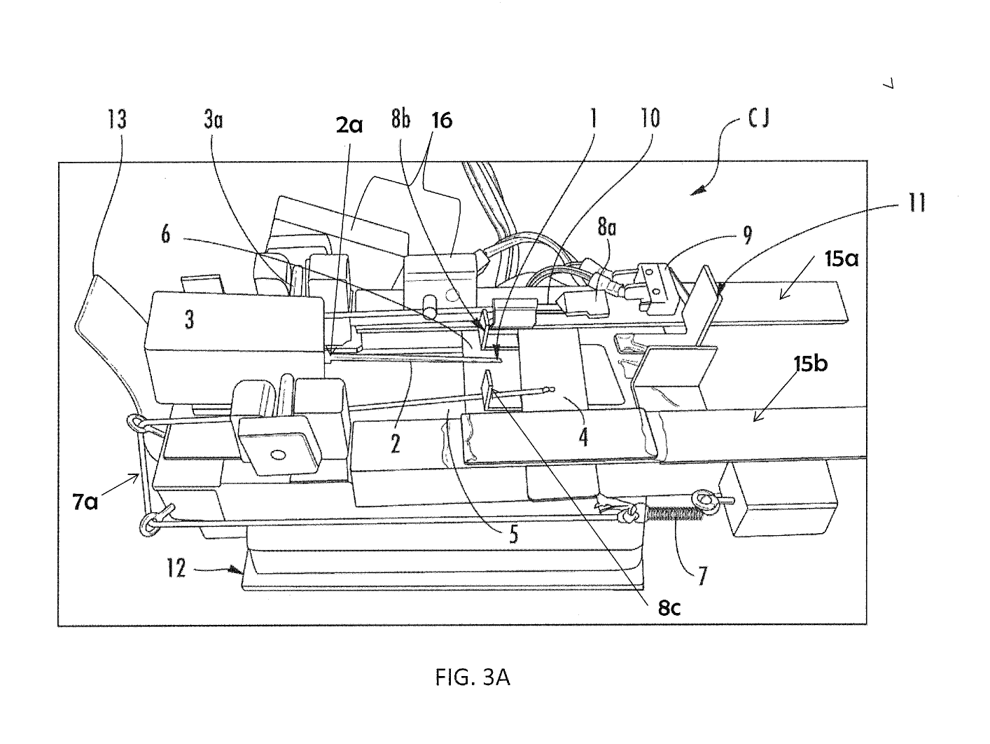

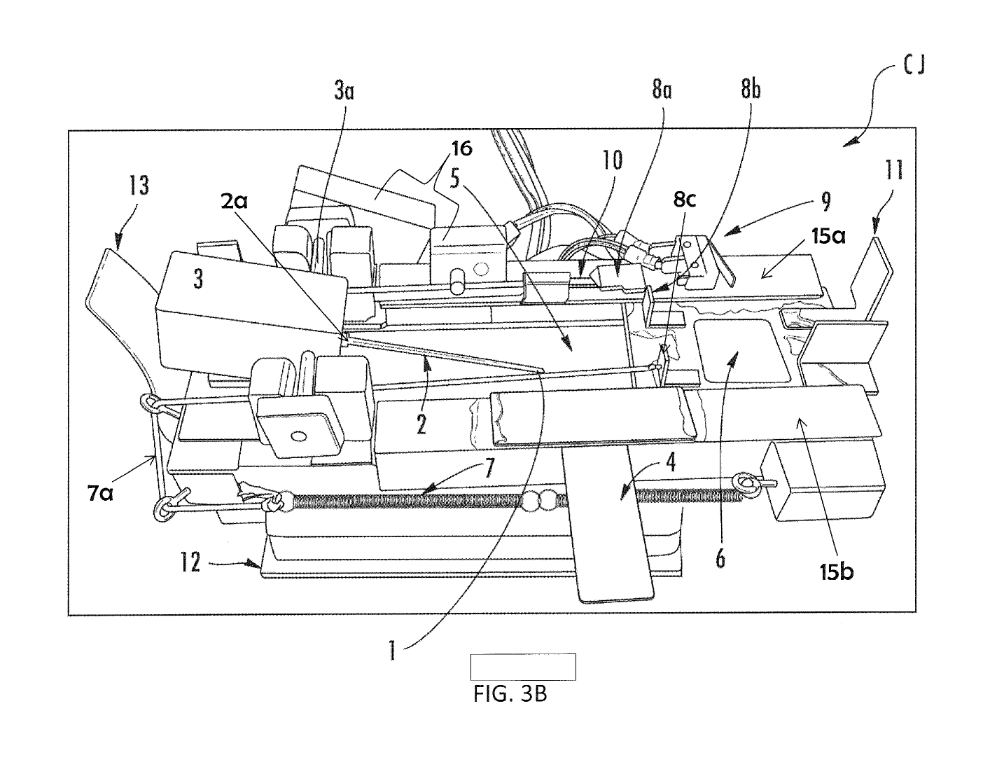

FIG. 3A illustrates an embodiment of a Cryo Jig in a “closed” position for sample loading and/or sample warming. In Cryo Jig CJ of FIG. 3A, the sample can be positioned at end 1 of a blade-type sample manipulation device comprising shaft 2. The other end 2a of shaft 2 is attached to holder 3, which comprises a block (e.g., a wooden block) which can rotate around shaft 3a (e.g., a metal rod). End 2a of shaft 2 can be inserted in a hole in holder 3, for example.

In the sample loading/sample warming configuration shown in FIG. 3A, optional removable ruler 4 is positioned beneath end 1. Ruler 4 can be used when Cryo Jig CJ is within a laser chamber (e.g., of a vertically directed laser) to aid in aligning the jig within the laser chamber and to aid in aligning end 1 (e.g., where a sample can be located) in the path of the laser beam. FIG. 3A also shows another optional component of Cryo Jig CJ, i.e., sliding base 12, which is underneath cooling medium chamber 5 and can be used to help position the jig inside a laser chamber. During initial studies with the Cryo Jig, the sliding base was constructed of ceramic floor tiles with thin felt pads which could slide upon similar tiles inside the laser chamber. Additionally, Cryo Jig CJ can include a shim (not shown) to assist in positioning the Cryo Jig in the z direction within a laser chamber.

Returning now to FIG. 3A, in the sample loading/sample warming configuration, sample 1 is positioned above cooling medium chamber 5, with shaft 2 of the sample manipulation device parallel to a plane formed by the top of chamber 5. Cooling medium chamber 5 as illustrated in FIG. 3A has a hollow cubic shape, with an opening at the top. Cooling medium chamber 5 can be prepared from any suitable thermally insulating material, such as a rigid insulating foam material, and can be sized appropriately, e.g. to fit inside the laser chamber and/or to hold a suitable volume of cooling medium sufficient to cool the sample at a desired rate. In some embodiments, the cooling medium is liquid nitrogen (LN₂).

For the purpose of initial studies with the Cryo Jig, the cooling medium chamber was prepared from pieces of STYROFOAM™ (Dow Chemical Company, Midland, Mich., United States of America) from cold shipping containers. STYROFOAM™ sheets were layered to provide a container of a suitable thickness and glued together with a waterproof silicone (i.e., GE Premium Waterproof Silicone; General Electric, Fairfield, Conn., United States of America). Any other suitable insulating material could be used to form the chamber. For example, the chamber could be molded from suitable insulating plastic foam in a single piece, eliminating the need to glue pieces together. Chamber 5 of FIG. 3A has internal dimensions of 90×50×30 mm (L×H×W). However, these dimensions are merely exemplary and can be altered depending upon typical sample size and/or on the size of the laser chamber in which the Cryo Jig is to be used.

In FIG. 3A, cover slide 6 is positioned between end 1 and cooling medium chamber 5. Cover slide 6 is used to protect the sample from LN₂ vapor while the sample is being loaded and when the sample is being warmed. Cover slide 6 is operably attached to spring 7. Also attached to cover slide 6 is cover slide tab 8b and cover slide tab 8c. Spring 7 is attached to cord 7a which is attached to tab 8c. The side edges of cover slide 6 are inserted in and can slide within grooves in side supports 15a and 15b. Rotatable trigger rod 10 is attached to holder 3. Attached to trigger rod 10 is tab 8a. Also attached to trigger rod 10, but hidden from view in FIG. 3A is a tab that is pressed down by holder 3, causing trigger rod 10 to rotate when holder 3 is pressed. The jig can optionally include components to help stabilize the trigger rod. As illustrated in FIG. 3A, stabilizer 16 is attached to side support 15a to stabilize trigger rod 10. Stabilizer 16 includes wooden blocks with a side peg arranged along part of the side and top of rod 10. Other types of materials or configurations of materials can be used for the stabilizer so long as they do not impede the rotation of rod 10.

On the right-hand side of the jig as shown in FIG. 3A is contact switch tab 11, which is attached to cover slide 6 and which is pressing contact switch 9. Switch 9 can be, for example, a NTE 54-417 micro switch (NTE Electronics, Bloomfield, N.J., United States of America) or another suitable switch that can be closed with relatively little pressure. Switch 9 can be in electronic communication with a laser and configured to fire the laser when closed.

On the left-hand side of the jig is friction tab 13, which is used to stabilize holder 3 while the jig is in the loading/warming position. As illustrated in FIG. 3A, tab 13 comprises a VELCRO™ surface. However, other types of material could be used instead, so long as they can act to hold the holder in position via friction but do not restrict movement of the holder so much as to interfere with manual rotation of the holder from one position to another.

FIG. 3B illustrates an embodiment of a Cryo Jig in the cooling configuration, where cover slide 6 is slid to the right-hand side of Cryo Jig CJ exposing an opening at the top of chamber 5. Holder 3 is rotated about shaft 3a such that shaft 2 is tipped down toward chamber 5 and end 1 is positioned inside cooling chamber 5. In the rotated position, holder 3 is in less contact with friction tab 13 than when in the position shown in FIG. 3A. Removable ruler 4 is pulled out so that it not under sample 1 or over the opening of chamber 5. Trigger rod 10 and tab 8a are rotated from their positions in FIG. 3A and tab 8a holds tab 8b such that cover slide 6 has slid in the grooves of side supports 15a and 15b such that it is held away from the opening of chamber 5. Spring 7 is in an extended position relative to its position in FIG. 3A. Cord 7a is pulled further to the right-hand side of the jig by tab 8c. Tab 11 is pushed to the right and micro switch 9 is open. FIG. 3B also shows an optional additional component of Cryo Jig CJ, i.e., sliding base 12, which is underneath the bottom of chamber 5 and which, as described with regard to FIG. 3A, can be used to help position the jig inside a laser chamber. End 2a and stabilizer 16 are also as described for FIG. 3A.

During operation of the Cryo Jig (e.g., moving the jig from the cooling position of FIG. 3B to the loading/warming position of FIG. 3A), the left end of holder 3 can be pressed manually, tipping end 1 of shaft 2 out of the LN₂ or other cooling medium in chamber 5, releasing cover slide 6 to cover the opening of chamber 5 via the actions of trigger rod 10, tab 8a, and spring 7, and firing a laser as cover slide 6 slides into position and tab 11 closes contact switch 9.

The exemplary operational details for cooling and warming an oocyte sample are as follows: Chamber 5 is filled with LN₂. Cover slide 6 is then moved to left (i.e., to the closed position) to isolate end 1 of shaft 2 from the LN₂ and/or LN₂ vapor. End 1 of shaft 2 where the sample is to be located is positioned in the x and y positions at the location where the laser beam will strike, e.g., by manually sliding the jig within a laser chamber. This positioning can be aided by the use of cross hairs in a stereomicroscope built into a laser. From this point on, the jig as a whole cannot be moved.

In parallel, some five oocytes are transferred from a PB1 collection medium to a 50 μl droplet of the experimental medium with two washings intervening. At 1.5 min after the initial exposure to that medium, a 0.1 μl droplet of the test solution containing five oocytes or 2-cell embryos is placed on end 1. The z position of the jig can be held constant by a shim of appropriate thickness under the jig. At 2.0 min after the initial exposure of the oocytes or 2-cell embryos to the test solution, cover slide 6 is moved to the right to expose the LN₂ in chamber 5, and holder 3 is rotated manually to immerse the oocytes in the LN₂. This relatively short time reduces evaporation of the droplet prior to cooling and was previously shown suitable for yielding good survival of mouse oocytes after vitrification.

To initiate warming, the left side of holder 3 is pressed down (e.g., manually) to lift shaft 2 and end 1 out of chamber 5 and into a horizontal position. This depresses trigger tab 8a, which releases tab 8b, such that cover slide 6 can slide to the left, covering chamber 5. When cover slide 6 slides into position over chamber 5, tab 11 hits switch 9, which can fire the laser. This entire operation is completed in <0.25 s.

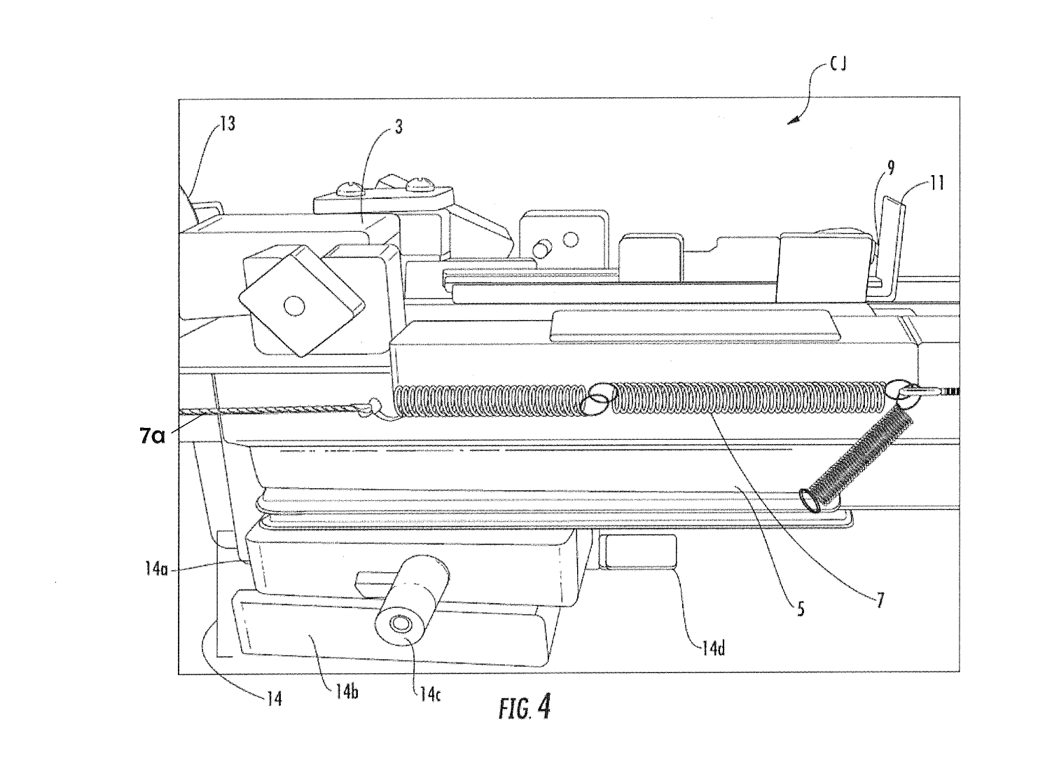

In addition to the components described above with regard to FIGS. 3A and 3B, the Cryo Jig can optionally be mounted on an x-y stage to aid in alignment. For instance, the x-y stage can be placed between the jig and the floor of a laser chamber to provide for precise x-y positioning of the biological sample in the laser beam. FIG. 4 illustrates an embodiment of a Cryo Jig mounted on x-y stage 14, which includes two Thorlabs DT25 stages (Thorlabs, Newton, N.J., United States of America), 14a and 14b, which are stacked at right angles and have manual adjustment knobs 14c and 14d. Stages 14a and 14b are each 20 mm thick and can provide an inch of adjustment. Any other suitable stage(s) can be used, so long as the stage(s) can fit into the laser chamber with the jig or so long as the jig can be adjusted (e.g., by changing the dimensions of the cooling medium chamber) so that the entire assembly can fit in the laser chamber. Cryo Jig CJ of FIG. 4 is the similar to that described for FIG. 3A, excepting that the height of the cooling medium chamber 5 is reduced from 50 mm to 36 mm. Friction tab 13, holder 3, contact switch 9, contact switch tab 11, spring 7, and cord 7a of Cryo Jig CJ are visible in FIG. 4.

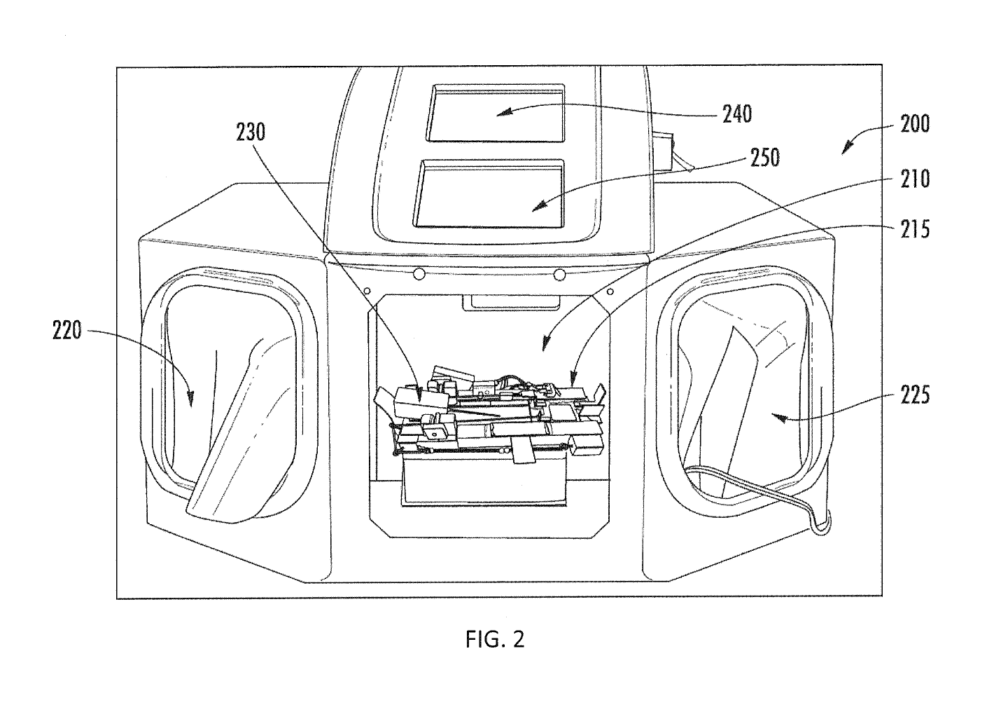

FIG. 2 shows an embodiment of the Cryo Jig from FIGS. 3A and 3B positioned inside the chamber of a laser to provide an exemplary warming system of the presently disclosed subject matter. The system shown in FIG. 2 includes a Laser Star iWeld 990 series laser (LaserStar Technologies, Riverside, Rhode Island, United States of America), the laser used in the Examples below. The laser was chosen as it had suitable size, power, pulse duration, and safety features. The laser is a Nd:YAG laser that emits at 1064 nm and was originally designed for jewelry welding. The Laser Star iWeld 990 series laser used in the Examples below has a laser chamber that measures 254 mm×534 mm×406 mm and a laser with an adjustable beam diameter of from about 0.05 mm up to about 2 mm and is directed vertically, downward onto the top of the Cryo Jig. The laser pulse is also adjustable and can be from 0.1 to 30 milliseconds (msec). The laser is capable of providing a uniform spatial energy distribution, which can be desirable for warming a sample evenly. The laser used in the Examples below can deliver up to 40 Joules of energy. (However, higher energy lasers could be desirable for use with larger samples.) Power is the product of the energy delivered times the time over which it is delivered. In addition to welding lasers, such as the iWeld laser, a suitable medical or research laser could also be used. Moreover, lasers of different wavelengths can also be used.

FIG. 2 shows system 200, which includes a laser, with the front panel of laser chamber 210 removed to show Cryo Jig 215 inside. The laser chamber includes arm hole ports 220 and 225 for insertion of an operator's arms to aid in positioning of Cryo Jig 215 and in pressing holder 230 of Cryo Jig 215. The system also includes control panel 240 and viewing window 250 to aid in visual positioning of Cryo Jig 215. System 200 can also include a microscope (not shown) to aid in positioning of the sample. If present, the eyepieces for the microscope can be located above control panel 240.

Accordingly, in some embodiments, the presently disclosed subject matter provides a jig for a system for the rapid cooling and warming of a sample comprising a cell or tissue, wherein the sample further comprises a medium, the jig comprising: (a) a holder adapted for movement between a first position and a second position; (b) a shaft connected to the holder, the shaft having a first end and a second end, wherein the first end connects the shaft to the holder and wherein the second end of the shaft is adapted to receive a sample comprising a cell or tissue, wherein the sample further comprises a medium; (c) a trigger adapted for activation when the holder is moved from the first position to the second position; and (d) a switch operable to activate a heating source when the trigger is activated. In some embodiments, the holder of (a) can be a block fitted with a hole for receiving the first end of the shaft (e.g., the shaft of a sample manipulation device typically used for vitrification of oocytes and/or embryos). The block can move between the first and second positions by rotation around an axis through the block. The block can comprise any suitable material (e.g., wood, metal, plastic).

In some embodiments, the trigger can comprise a rotatable rod (e.g., a metal, plastic or wooden rod) and one or more tabs attached to the rod. Movement of the holder from the first position to the second position can cause the rod to rotate. In some embodiments, the trigger further comprises a cover operable to isolate a sample from a cooling source upon movement of the holder from the first position to the second position. In some embodiments, the cover is adapted for movement between a first cover position and a second cover position and is operably connected to the trigger such that the trigger actuates movement of the cover between the first cover position and the second cover position.

In some embodiments, the presently disclosed subject matter provides a system for the rapid cooling and warming of a sample comprising a cell or tissue, wherein the sample further comprises a medium, the system comprising: (a) a jig comprising (i) a holder adapted for movement between a first position and a second position; (ii) a shaft connected to the holder, the shaft having a first end and a second end, wherein the first end connects the shaft to the holder and wherein the second end of the shaft is adapted to receive a sample comprising a cell or tissue, wherein the sample further comprises a medium; (iii) a trigger adapted for activation when the holder is moved from the first position to the second position; and (iv) a switch operable to activate a heating source when the trigger is activated; (b) a heating source; and (c) a cooling source; wherein the heating and cooling sources are operably arranged with respect to the jig such that the sample can be contacted by the cooling source at the first position of the holder of the jig and the sample can be contacted by the heating source at the second position of the holder of jig.

In some embodiments, the heating source is a laser. In some embodiments, the laser has a wavelength in the infrared range (i.e., a wavelength between about 700 nm and about 1 mm). In some embodiments, the laser emits at a wavelength that is not appreciably absorbed by the cell or tissue of the sample. In some embodiments, the laser has a wavelength of 1064 nm. In some embodiments, the laser has a wavelength of 2100 nm. In some embodiments, the laser emits light into a chamber adapted with holes for insertion of an operator's arms and/or a viewing window (e.g., to help the operator align a sample to be warmed in the laser beam). In some embodiments, the laser is part of an apparatus further comprising a microscope to aid in aligning a sample in the laser beam. Suitable lasers include those known for use in research, medicine, and industry (e.g., jewelry welding).

In some embodiments, the cooling source is a reservoir adapted to receive a cooling medium. In some embodiments, the cooling medium is liquid nitrogen and/or liquid nitrogen vapor. The reservoir can comprise any suitable insulating material or materials, e.g., polystryrene foam. In some embodiments, the cooling source or trigger further comprises a cover that is adapted for movement between a first cover position and a second cover position (e.g., where one position is where the cover is located to provide an opening into the reservoir and where the other position is where the cover is located to cover and/or close the opening). In some embodiments, the cover is operably connected to the trigger, wherein the trigger actuates movement of the cover between the first cover position and the second cover position.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### General Methods for Handling Oocytes and Embryos

Obtaining oocytes: Mature female ICR mice were induced to superovulate with intraperitoneal injections of 5 International units (IU) of equine chorionic gonadotropin (eCG) and 5 IU of human chorionic gonadotropin (hCG) (Sigma, St. Louis, Missouri, United States of America) given 48 hours apart. Ovulated unfertilized oocytes were collected from the ampullar portion of the oviducts 13 hours after hCG injection and were freed from cumulus cells by suspending them in modified phosphate-buffered saline (PB1) containing 0.5 mg/ml hyaluronidase followed by washing with fresh PB1 medium.

Obtaining 2-cell embryos: Female ICR mice (8-12 weeks old) were induced to superovulate with intraperitoneal injections of 5 IU of pregnant mare serum gonadotropin (PMSG) and human chorionic gonadotropin (hCG) (Sigma, St. Louis, Mo., United States of America) given 48 hours apart. Females were mated with mature males of the same strain. To collect 2-cell embryos, the oviducts of mated females were flushed with modified phosphate buffered saline (PB1) medium 45 hours after the injection of hCG. The collected embryos were washed and pooled in fresh PB1 medium in a culture dish under paraffin oil to await each suite of experiments.

Preparing the test solutions: Table 1, below, shows the molalities of the solutes used in this study. All the solutions were prepared on a molal basis, where molality is moles of solute/kilogram (kg) water; i.e., the necessary moles of each solute were weighed out on an analytical balance and 100 grams (g) of PB1 added. PB1 is >99% water, so the substitution of PB1 for water introduces less than 1% error.

Achieving ultra-high warming rates via a laser: As previously described, a warming rate of 117,000° C./min can be achieved by transferring a CRYOTOP® (Kitazato BioPharma Co. Ltd., Fuji, Japan) with 5 oocytes in a 0.1 μl droplet of medium from −196° C. into 0.5 M sucrose in a modified isotonic phosphate buffered saline at 23° C. See Seki and Mazur, PLoS Once (4):e36058 (2012); and Jin et al., Cryobiology, 68 (2014), 419-430. A CRYOTOP® comprises a thin plastic blade measuring 0.7 mm wide, 0.1 mm thick, and 20 mm long that is inserted into a plastic handle. FIG. 1 is an illustration of a CRYOTOP®-type sample holder blade modified with a thermocouple to measure warming rate.

To achieve more rapid warming, a powerful short duration laser pulse was applied to a droplet on an CRYOTOP®, using a Nd:YAG laser manufactured by LaserStar Corp. (Riverside, R.I., United States of America). Sample holders used in the presently disclosed studies did not include a thermocouple or material for holding a thermocouple at the site of sample attachment. Warming rates were calculated as described further below. The laser emits at 1064 nm, which is in the near infrared. The water-rich medium and cell contents absorb poorly at 1064 nm wave-length (˜3.5%). Thus, a low concentration of carbon black (India Ink) was introduced into the solution. Carbon black is a black body that absorbs all wave lengths. Therefore, the μm-sized India Ink particles can absorb the laser IR energy and be abruptly heated. They can also transfer this heat to the surrounding solution, which in turn can transfer it to the oocyte. The India Ink particles are too large to penetrate the zona pellucida, the non-living envelope surrounding the oocyte. Consequently, they cannot come in contact with the plasma membrane, much less penetrate the cell. Moreover, based on prior reports related to molecular tweezers, it is believed that the small fraction of the incident laser energy absorbed by the cells themselves is too low to cause injury. See Liu et al., Biophys. J., 68 (1995), 2137-2144; and Zhang and Liu, J.R. Soc. Interface., 5 (2008), 671-690.

The Cryo Jig: Oocyte samples were cooled by abrupt immersion of an uninsulated CRYOTOP® into liquid nitrogen (LN₂). This treatment produces a cooling rate of 69,000° C./min. See Kleinhans et al., Cryobiology, 61, (2010), 231-233. A Cryo Jig was fashioned to permit the cooled CRYOTOP® to be held in LN₂ inside the chamber of the laser apparatus until warming was initiated by the laser pulse. See FIGS. 3A, 3B, and 4.

Warming rates were calculated by assuming that WR=(ΔT/Δt) (although this ignores some complexities discussed below in Example 3). The first step was to decide on the temperature range (ΔT) over which the laser pulse is to be applied. The end point is −3.5° C., the melting point of 0.33× EAFS. The starting point is taken to be −180° C., e.g., based on an estimate of how much the sample warms in air between its removal from LN₂ and the firing of the laser. The duration of the pulse needed to warm at the desired rate is Δt=ΔT/WR. For the desired warming rates of 7.0×10⁵, 3.0×10⁶, and 1.0×10⁷° C./min from −180° C. to −3.5° C., the pulse durations needed to be 15, 3.5, and 1 msec, respectively. (The two lower rates were used only to a limited extent).

Using the stereo microscope built into the laser apparatus, it was determined for each set of runs, whether a given laser power setting resulted in a still frozen droplet, a fully melted droplet, or a clearly heat-altered oocyte. The power required to achieve the second state was selected. In addition, a control accompanied each run. It comprised oocytes on naked CRYOTOP® blades transferred from LN₂ to the 0.5 M sucrose solution at 23° C. No laser was used. These controls warmed at 1.2×10⁵° C./min from −180° C. to −3.5° C. See Seki and Mazur, PLoS One (4):e36058 (2012).

Post-vitrification procedures: After laser pulse warming, the CRYOTOP® blade was immersed with gentle shaking in 2 ml of 0.5 M sucrose in PB1 in a 35 mm culture dish at 23° C. The procedure to warm at 117,000° C./min without laser assistance was identical except the laser pulse was omitted. The oocytes and 2-cell embryos were then collected and transferred to fresh 100 μl droplets of the same sucrose solution for 10 min. The purpose of the 10 minute exposure to hypertonic sucrose is to prevent injurious osmotic swelling resulting from the influx of water and consequent dilution of any cryoprotective solutes that entered the cells prior to vitrification. For plasma membranes that are intact at this point, the cells shrink during the 10-min exposure if any cryoprotectants have permeated (EG or acetamide) and are flowing out. For some of the solutions (e.g., Solutions 11, 12, and 13 in Table 1, below), there were no permeating solutes, and in those cases, the warming solution was PB1 without any sucrose.

Determination of survival of oocytes and 2-cell embryos: Two representative methods were used to assess survivals after treatment. One method was determining membrane intactness and morphological normality by previously described procedures. See Mazur et al., Cryobiology 51 (2005) 29-53. The second method was to determine the functional survival of both oocytes and 2-cell embryos for those treatments that yielded high osmotic/morphological survival. Two measures of functional survival were used. One was the ability of the treated oocytes to be fertilized in vitro by sperm and to develop to expanded blastocysts in culture. The other was to collect and vitrify naturally developed 2-cell embryos and determine their ability to develop to expanded blastocysts in vitro.

Survival based on morphology and membrane intactness: After warming from −196° C. and a 10 minute exposure to 0.5 M sucrose in PB1, the oocytes or 2-cell embryos were transferred to sucrose-free PB1 and then to Cook Cleavage medium (Catalog name: K-RVCL; Cook Medical Inc., Bloomington, Ind., United States of America), in which they were incubated for 2 hours at 37° C. The percentage exhibiting normal morphology and volumes at this point are scored as survivors.

Functional survivals of oocytes based on IVF and ability to develop to expanded blastocysts: After warming from −196° C. and 10 minutes of exposure to 0.5 M sucrose in PB1, the oocytes were transferred into sucrose-free PB1, washed three times in Cook IVF medium (K-RVFE; COOK Medical Inc., Bloomington, Indiana, United States of America), and then groups of five oocytes were transferred into each of several 100 μl drops of the IVF medium that contain a measured concentration of sperm. The pre-collected sperm had been diluted 100-fold initially and their concentration determined by haemocytometer. They were further diluted to produce samples containing 1×10⁶ or 3 ×10⁶ sperm/ml. This translates to 2×10⁴ and 6×10⁴ sperm/oocyte. Lower or higher concentrations of sperm yielded significantly poorer percentages of fertilization. The zona pellucidae were intact and untreated and still yielded high percentages of IVF. This is unlike previous reports where poor fertilization percentages were obtained unless the zonae were partially dissected. See Seki and Mazur, PLoS One 7 (4):e36058 (2012). Without being bound to any one theory, the difference is believed to relate to the close attention paid to the sperm concentration in the present studies.

After incubation for 5 hours in the Cook fertilization medium at 37° C. under 5% CO₂/95% air, the fertilized oocytes were transferred after washing from the Cook IVF medium to 100 μl droplets of Cook Cleavage medium and incubated for 5 days under 5% CO2/95% air to permit development to expanded blastocysts. The Cook IVF medium is a variant of HTF medium and Cook Cleavage medium is a variant of KSOM-AA medium, the compositions of which were previously described. See Nagy et al., Manipulating the Mouse Embryo: A Laboratory Manual (Cold Spring Harbor Laboratory Press, Woodbury, N.Y., ed. 3, 2003, pp. 570, 572, and 577-579).

Statistics: The studies described in Example 2, below, involved 36 conditions; 18 for a laser-induced warming rate of 1.0×10⁷° C./min and 18 for the control warming rate of 1.2×10⁵° C./min. Each test condition was usually repeated 8 times (N) with 5 oocytes per condition per run; i.e., 40 oocytes per condition. This amounts to 1440 oocytes in all. Errors are reported as Standard Errors; i.e., standard deviations of the mean.

### Example 2

### Survival as a Function of Osmolality of the Vitrification Medium and Warming Rate

A high percentage of mouse oocytes survive vitrification in an EAFS solution diluted to half of normal when the oocytes are warmed at 117,000° C./min on a CRYOTOP®. See Seki and Mazur, PLoS One 7(4):e36058 (2012). However, only 5% survived when the EAFS was diluted 3-fold. An aim of the present study was to determine whether survival in a 3-fold diluted solution could be increased by using a laser pulse to raise the warming rate as much as 100-fold.

The Standard EAFS solution for mouse oocytes consists of ethylene glycol (EG), acetamide, sucrose, and Ficoll dissolved in isotonic phosphate buffered saline (PB1). See Pedro et al., Cryobiology, 35, (1997), 150-158. The oocyte is highly permeable to EG and acetamide. See Edashige et al., Biol. Reprod., 77, (2007), 365-375; and Pedro, “Studies on the Cryopreservation of Mammalian Oocytes and Embryos with Reference to Some Cryobiological Characteristics,” Ph.D. Thesis, Chapter 3, United Graduate School of Agricultural Sciences, Ehime University, 1997. However, it is impermeable to the other components of the composition. The composition is typical of vitrification solutions in that it consists of permeable and non-permeable solutes, low and high molecular weight solutes, and has a very high total molality (i.e., 7.38, see top entry, Table 1).

A previously used 0.33× EAFS is Solution No. 2 in Table 1. See Seki and Mazur, Biology of Reproduction, 79 (2008), 727-737. Its total molality is 1.72, about ¼th that of full-strength EAFS. Solutions Nos. 1 and 3 to 10 of Table 1 give the compositions of modifications of the standard 0.33× EAFS. Solutions Nos. 11-13 of Table 1 represent solutions where no permeating solutes were present. The two right-hand columns of Table 1 give the osmotic/morphological survival after laser warming at 10⁷° C./min and after warming in a sucrose salt solution at 10⁵° C./min with no laser.

TABLE 1
Survivals of Mouse Oocytes Vitrified in Modifications of 0.33 x EAFS.

| | | | | | | | Survival | Survival |
|---|---|---|---|---|---|---|---|---|
| | | | | | | | % warm at | % warm at |
| | | Molal | Molal | Molal | Molal | Total | 1 × 10⁷° | 1.2 × 10⁵° |
| No. | Solution | EG | ACET | Sucrose | Ficoll | Molal* | C./min | C./min** |
| | 1xStd | 3.23 | 3.27 | 0.72 | 0.0062 | 7.38 | — | 91.7 ± 6.3 |
| 1 | 0.33xStd F0 | 0.7 | 0.71 | 0.16 | 0 | 1.72 | 49 ± 8.9 | 0 |
| 2 | 0.33xStd | 0.7 | 0.71 | 0.16 | 0.0013 | 1.71 | 66 ± 6.0 | 24 ± 5.0 |
| 3 | 0.33x-1 F0 | 0.7 | 0.71 | 0.72 | 0 | 2.28 | 86 ± 4.8 | 36 ± 10 |
| 4 | 0.33x-1 | 0.7 | 0.71 | 0.72 | 0.0013 | 2.28 | 96 ± 2.7 | 28 ± 8.0 |
| 5 | 0.33x-2 | 0.7 | 0.71 | 0.72 | 0.0062 | 2.29 | 74 ± 6.8 | 30 ± 9.3 |
| 6 | 0.33x-3 | 0.7 | 0.71 | 1.00 | 0.0062 | 2.57 | 71 ± 7.3 | 0 |
| 7 | 0.33x-4 | 0.7 | 0.71 | 0.50 | 0.0062 | 2.07 | 92 ± 3.3 | 26 ± 7.2 |
| 8 | 0.33x-5 | 0.7 | 0.71 | 0.25 | 0.0062 | 1.82 | 86 ± 4.7 | 70 ± 6.5 |
| 9 | 0.33x-6 | 0.7 | 0.71 | 0.16 | 0.0062 | 1.73 | 84 ± 7.5 | 76 ± 7.5 |
| 10 | 0.33x-7 | 0.7 | 0.71 | 0 | 0.0062 | 1.57 | 80 ± 3.8 | 67 ± 8.4 |
| 11 | 0xStd | 0 | 0 | 0.72 | 0.0062 | 0.88 | 70 ± 6.7 | 0 |
| 12 | 0xStd-1 | 0 | 0 | 0.72 | 0.0013 | 0.87 | 84 ± 3.5 | 0 |
| 13 | 0xStd- F0 | 0 | 0 | 0.72 | 0 | 0.87 | 59 ± 9.3 | 0 |

*each solution also contained 0.15 Molal NaCl;
**the survival % in 1xStd solution at a wanning rate of 1.2 × 10⁵° C. is from Seki and Mazur, PLoS One 7 (2012) 4: e36058.

5

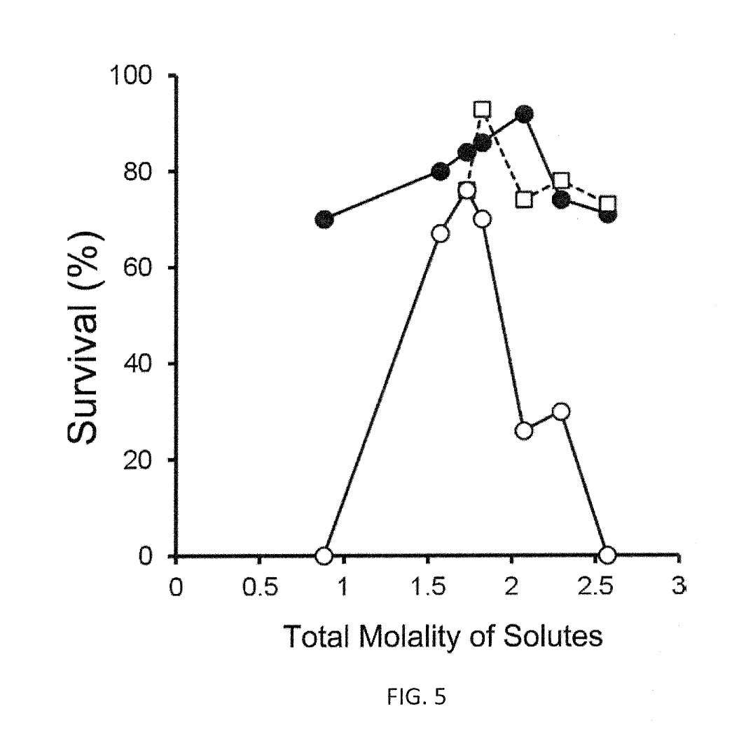

FIG. 5 plots the survivals after the vitrification and warming of oocytes suspended in solutions where the total molalities ranged from 0.88 to 2.57 (Solutions Nos. 5-11 of Table 1). In all except Solution 11, the molalities of EG and acetamide remained constant at 1.41 molal. In Solution 11, EG and acetamide were absent. The only variable in the former group was the concentration of sucrose which ranged from 0 to 1.0 molal. In initial studies, the CRYOTOP®s were warmed at four different estimated rates; namely, 1.0×10⁷, 3.0×10⁶, 7.0×10⁵, and 1.2×10⁵° C./min. In later studies, only the first and 4th rates were used. The three highest warming rates (calculated) were achieved with the use of the laser. The lowest warming rate was not.

As shown in FIG. 5, three curves are plotted; curves for survivals after warming at the lowest and highest rates, and a curve at the mean of the two intermediate rates. All three curves are inverted “V”s, with maximum survivals of 92% in 2.07 molal solution, 93% in 1.82 molal, and 76% in 1.73 molal, for the fastest to slowest warming, respectively. With the fastest laser-induced warming, four of the 7 survivals exceeded 80% and all 7 were 70% or higher. In contrast, the survivals in 5 of the 7 sets warmed without the laser were below 70%, and two were 0%. High survivals (76%) were obtained with the non-laser warming if the oocytes were suspended in a 1.73 molal solution, but the survivals decreased abruptly when the molalities were decreased or raised below or above that value. That is, the high survival response surface for the laser-warmed samples was broader than that for the non-laser warmed samples.

To determine whether survival was based more on the total molality of the permeating solutes or on the total molality of both the non-permeating and permeating solutes, five solutions were prepared, each having a total molality of 2.0 but differing in the proportions of permeating solutes (EG+acetamide) to non-permeating (sucrose); namely, ∞, 4.4, 1.9, 1.2, and 0.84. The molalities of NaCl and Ficoll were held constant at 0.15 and 0.0062. The survivals after warming the samples at 1.0×10⁷° C./min by laser and at 1.2×10⁵° C./min without the laser in a 23° C. sucrose solution are given in Table 2. With the laser-induced warming, there was no significant effect of changing the ratios of the molality of the permeating solutes to the molality of the non-permeating from infinity to 1.9, and the grand mean survival was 96%. However, with the two lower ratios, the survivals dropped to 71 and 59%. With non-laser warming at 1/75^{th} that rate, the grand mean survival was only 15%, and the ratio had an effect; i.e., solutions CTM 1 and CTM 2, which had ratios of ∞ and 4.4, yielded a mean survival of 34% whereas, those with ratios of 1.9, 1.2, and 0.84 exhibited mean survivals of only 1.7%.

TABLE 2
Survival with Constant Total Molality (CTM) but Varying
Ratios of Molality of EG and acetamide to sucrose.

| | | | | | | | Survival | Survival |
|---|---|---|---|---|---|---|---|---|
| | | | | | | | % warm at | % warm at |
| | | Molal | Molal | Molal | Molal | Total | 1 × 10⁷° | 1.2 × 10⁵° |
| No. | Solution | EG | ACET | Sucrose | Ficoll | Molal* | C./min | C./min |
| 14 | CTM-1 | 0.92 | 0.92 | 0 | 0.0062 | 2.00 | 100 | 25 ± 6.3 |
| 15 | CTM-2 | 0.75 | 0.75 | 0.34 | 0.0062 | 2.00 | 93 ± 3.7^{a} | 43 ± 11 |
| 16 | CTM-3 | 0.60 | 0.60 | 0.64 | 0.0062 | 2.00 | 95 ± 3.3 | 5 ± 3.3 |
| 17 | CTM-4 | 0.50 | 0.50 | 0.84 | 0.0062 | 2.00 | 71 ± 4.8 | 0 |
| 18 | CTM-5 | 0.42 | 0.42 | 1.00 | 0.0062 | 2.00 | 59 ± 10 | 0 |

Standard errors based on N = 8, except for solutions 17 and 18, laser warming, where N = 12.
*each solution also contained 0.15 Molal NaCl;
^{a}an initial eight runs yielded a survival of 74%. Due to possible large particle-size and clumping in the India ink (which would affect laser absorptivity), a repeat of eight runs was performed using a fresh source of ink checked for more uniform particle size. The repeat eight runs yielded the 93% survival shown in the table.

Functional survivals: Functional survivals were determined for two of the conditions in Table 1 that yielded very high morphological and osmotic normality. These were solutions 0.33-4 and 0.33-5 (Numbers 7 and 8). The first assay was the ability of the oocytes vitrified in these solutions and warmed at the highest laser-induced rate (1.0×10⁷° C./min) to undergo IVF and develop in vitro to expanded blastocysts. Thus, after vitrification, the oocytes were exposed to freshly collected sperm diluted to a concentration of 3×10⁶/mL with Cook Fertilization medium. The results are shown in Table 3. Some 90% of the oocytes had normal morphology after vitrification. A mean of 96% of those underwent fertilization and developed to the 2-cell stage. A mean of 60% of vitrified oocytes with normal morphology developed to expanded blastocysts as compared with 80% for fresh controls. The 0.33-4 and 0.33-5 solutions yielded about the highest morphological survivals after vitrification of those tried. They are both modified 3-fold dilutions of standard full strength EAFS-10-10 vitrification solution with the compositions given in Table 1. The oocytes in those solutions were cooled to −196° C. at about 69,000° C./min and warmed by laser at an estimated 1.0×10⁷° C./min.

The second functional assay was the ability of in vivo-developed 2-cell embryos to survive vitrification in Solution 0.33-4 and laser warming, and develop in vitro into expanded blastocysts. As shown in Table 3, a mean of 92% were morphologically normal after warming at the highest rate. Some 88% of these developed into expanded blastocysts, essentially the same as in the controls. Samples of 2-cell embryos were also warmed 100-times more slowly at 10⁵° C./min. However, only 5% were morphologically normal and 0/20 developed to expanded blastocysts.

TABLE 3
Functional Survival of Fresh and Vitrified
Mouse Oocytes and 2-Cell Embryos.

| | Number of | | | | |
|---|---|---|---|---|---|
| | eggs/2-cell | | | | |
| Vitrifi- | embryos | N (% | | | N (% |
| cation | (number | Morphology | | N (% | Expanded |
| solution | of runs) | normal) | | 2-cell) | blastocyst) |
| Oocytes | | | | | |
| None | 40 (8) | 40 | (100) | 38 (95 ± 3.3) | 32 (80 ± 3.8) |
| (control) | | | | | |
| 0.33-4^{b} | 40 (8) | 36 | (90 ± 4.0) | 30 (83 ± 6.1) | 20 (56 ± 4.9) |
| 0.33-5^{b} | 25 (5) | 22 | (88 ± 4.9) | 19 (86 ± 8.0) | 11 (50 ± 6.4) |
| 2-Cell | | | | | |
| Embryos | | | | | |
| None | 20 (4) | 20 | (100) | — | 16 (80 ± 11.5) |
| (control) | | | | | |
| Solution | 20 (4) | 20 | (100) | — | 17 (85 ± 9.6) |
| control | | | | | |
| 0.33-4 | 25 (5) | 23 | (92 ± 4.9) | — | 20 (88 ± 8.0) |

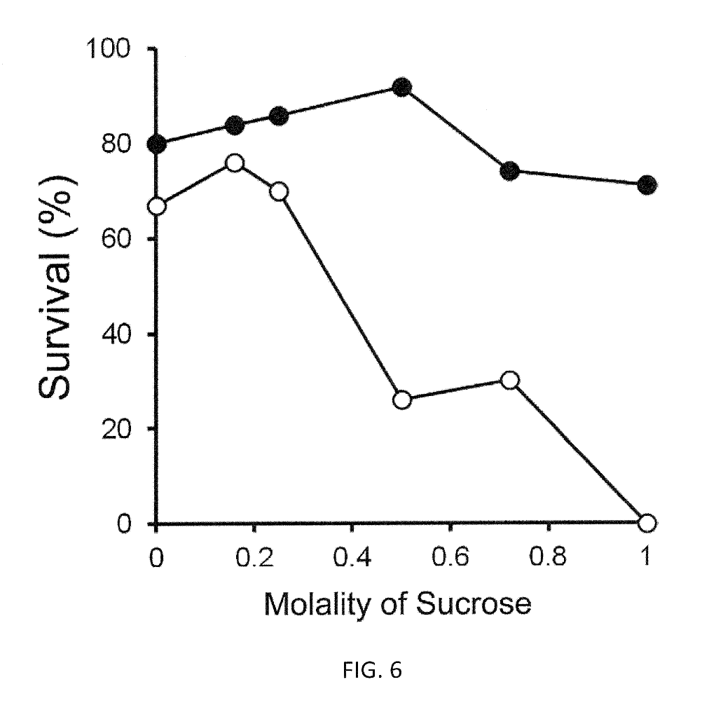

Survival as a Function of the Molality of Sucrose in the Vitrification Medium: FIG. 5 depicts the survival of vitrified oocytes as a function of the total molality of the solutes in the vitrification solution. As shown in FIG. 5, the survival curves are inverted “V”s with the apex or optimum solute concentration at about 2 molal. In most cases, the predominant contributors to the total molality are the permeating solutes EG and acetamide and the non-permeating solute sucrose. The question of whether survival is primarily determined by the molality of the permeating solutes or by that of the non-permeant species is of interest. In FIG. 6, the molality of the sucrose has been extracted from the total molality, and survival is plotted against the molality of the sucrose. If the oocytes are warmed at the highest laser-driven rate (closed circles), the survivals after vitrification are >80% with sucrose concentrations ranging from 0 to 0.5 molal. In contrast, when they are warmed about 100 times more slowly (open circles), survivals fall rapidly to 0% as the sucrose molality rises above 0.2. The results are partly confounded by the fact that the concentrations of EG and acetamide are also changing over this range, as can be seen for the appropriate solutions in Table 1.

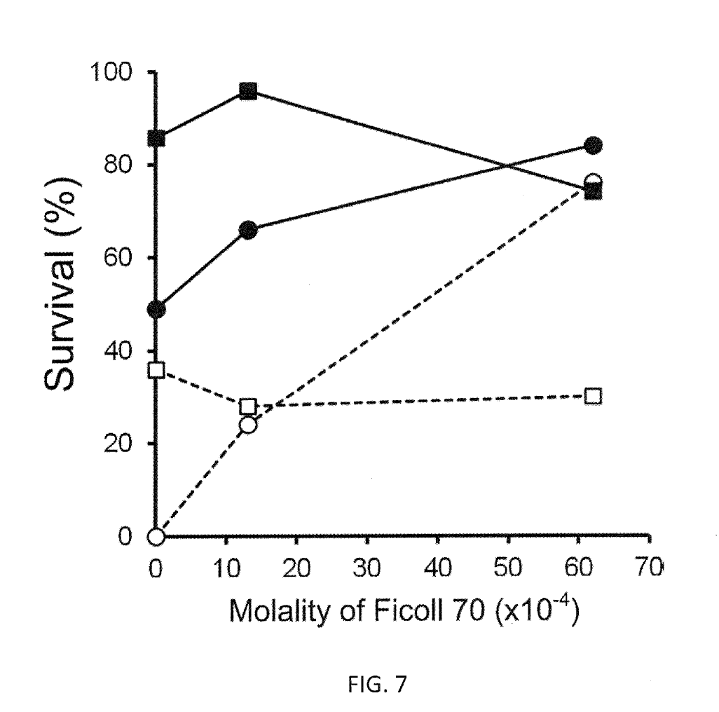

Survival after vitrification as a function of the molality of Ficoll in the vitrification medium: The standard full strength 1× EAFS contains 0.0062 molal Ficoll (24.5 wt %; 70,000 daltons). To assess its role, survivals were determined after oocytes were vitrified in media in which the Ficoll concentrations were 0, 0.0013, and 0.0062 molal with all other components held constant. The results are shown in FIG. 7. Four curves are shown, two each for warming rates of 1.0×10⁷° C./min and 1.2×10⁵° C./min, and two each for sucrose concentrations of 0.16 molal and 0.72 molal. In three of the four plots, the concentration of Ficoll appears to have relatively little effect. These three cases are the ultra-rapid laser-induced warming of solutions made with both 0.16 and 0.72 molal sucrose (closed symbols), and the solutions containing 0.72 molal sucrose and warmed much more slowly at 1.2×10⁵° C./min (open squares). The exception was the solution prepared with 0.16 molal sucrose and warmed relatively slowly (open circles). In that case, survivals ranged from 0% in the absence of Ficoll to 76% in the presence of 0.0062 molal Ficoll. Another way to describe the results is that in 0.0062 molal Ficoll, survivals exceed 75% in three of the four cases and are tightly grouped. On the other hand, in the absence of Ficoll, the survivals show an extreme range from 0% to 86%, the values depending on the sucrose concentration and warming rate.

The basis of the protection by Ficoll is not clear. It could be biological; e.g., it somehow protects the plasma membrane. But it also could be physical. For example, 0.0062 molal Ficoll has a weight percent of 24.5 in otherwise standard 0.33× EAFS (Solution 5 in Table 1). As such, it is highly viscous and forms a rather spherical droplet on the CRYOTOP®, whereas in its absence, the droplet spreads out. Without being bound to any one theory, this change in geometry could affect the thermal energy that is seen by an oocyte, since it would affect the number of carbon particles the laser beam encounters before reaching the oocytes.

The results described above appear to provide the following conclusions. First, that warming rate has an effect on survival. The highest survivals using the fastest laser-induced warming of 1.0×10⁷° C./min exceed those obtained using a rate of 1.2×10⁵° C./min (92% vs 76%). See FIG. 5. Further, with this highest rate of warming, survivals remain high over a rather broad range of total molalities, whereas when warming is 100-fold slower, high survivals are sharply restricted to a narrow zone of molalities. The greater sensitivity with the slower non-laser warming is also evident in Tables 1 and 2, and FIGS. 5 and 6. The poorer survivals with the slower warming are believed to be consistent with ascribing the lethality to the recrystallization of ice during warming.

Second, survival after vitrification and warming is strongly dependent on the total molality (and therefore, osmolality) of the suspending medium. The highest survivals appear to be when the suspending medium has a total molality close to about 2.0 molal. Concentrations are expressed as molalities rather than molarities because the former are much closer approximations than the latter to the chemical potentials of water and the solutes in the medium. It is the differences between these chemical potentials outside the cell and those inside the cell that determine the direction and rate of the movement of water and solutes under the present conditions.

Survival does not appear dependent, or only appears weakly dependent, on the mole ratio of the permeating to non-permeating solutes. The data supporting this conclusion are shown in Table 2. The permeating solutes here are EG and acetamide.

Third, survival after vitrification does appear to be affected by the extent to which the oocytes or embryos have become dehydrated just prior to vitrification. When cells are exposed to hyperosmotic solutions like those used here, they undergo abrupt osmotic shrinkage to a minimum volume, the value of which is determined by the ratio of the isotonic osmolality (˜0.3) to the total osmolality (non-permeating plus permeating solutes). This initial abrupt shrinkage is primarily a manifestation of water loss. It is abrupt because the permeability of cells to water is usually much higher than their permeabilities to solutes. The abrupt shrinkage is then followed by a slower swelling to a final equilibrium water volume, the rate of which depends primarily on the permeability coefficients of the permeating solutes. The final equilibrium volume is equal to the ratio of the osmolality of the solutes in an isotonic cell to the osmolality of the non-permeating solutes in the medium. Two minutes is probably very close to the exposure time that produces the maximum shrinkage of the cells, and is a time at which relatively few molecules of permeating solute have entered the cell. Quantitative estimates of how few molecules enter the cell can be obtained by experimental measurements of oocyte volumes vs. time in EAFS solutes and estimates of their permeability to water and to the solutes. Quasi-quantitative analysis supports the view that the ability of the EAFS solutes to protect the cells is primarily due to the extensive cell dehydration they produce prior to initiating vitrification and is only to a very limited extent a consequence of the permeation of EG and acetamide into the oocytes.

Two of the better media tested to obtain good survival after warming at the highest laser-induced rate appeared to be Solutions 0.33-4 and 0.33-5. With them, morphological/osmotic survivals and functional survivals were ≧80% with both cell stages. See Tables 1 and 3. Functional survival based on the IVF of oocytes and development to the 2-cell stage was 86%. See Table 3, column 4. This is higher than the 81% previously reported for oocytes vitrified in full-strength EAFS and subjected to partial zona dissection prior to IVF. See Seki and Mazur, PLoS One 7 (4):e36058 (2012). According to the presently disclosed subject matter, 88% of in-vivo derived 2-cell embryos were able to develop to expanded blastocysts after suspension in 3-fold diluted EAFS, vitrification, and laser-induced warming. See Table 3, column 5. This is almost as high as the 92% reported for the percentage of 8-cell embryos vitrified in full-strength EAFS that develop to blastocyst. See Seki et al., Cryobiology, 68 (2014), 21-28.

As summarized in Table 4, up to 92% survival was obtained with 1.8 molal VS when laser assisted warming was used. This concentration approaches the 1.64 molal (1.5 M) concentrations of EG and glycerol that have been used in slow freezing studies. It is possible that the much lower solute concentrations will reduce or eliminate adverse effects associated with the standard multi-molal solutions.

With respect to the permeation of VS solutes into cells, high survivals were obtained when the vitrification medium contains zero permeating solutes. See Table 1, solutions 11, 12, and 13. High survivals were also obtained when the protective media contains permeating solutes, but the 2.0 minute exposure time prior to initiating vitrification is so short that very little permeating solute has time to enter the cells. Without being bound to any one theory, these findings are believed to support protection arising much more from extensive osmotic cell water loss that from the penetration of VS solutes.

Most prior studies have placed emphasis on the need for the cooling rate to be extremely high, and with one exception, a cooling rate of 69,000° C./min was used in the presently disclosed studies. In that one exception, however, oocytes in Solution 0.33×-4 of Table 1 were cooled at about 10,000° C./min on a CRYOTOP® and laser warmed at 1.0×10⁷° C./min. This 7-fold slower cooling was achieved by placing the CRYOTOP® blade in liquid nitrogen vapor for 15 to 30 seconds about 6 mm above the surface of the liquid nitrogen. The temperature there is approximately −160° C. The blade was then immersed in LN₂ and laser warmed as usual. Survival was 95.5±3.3% (N=6), which is close to the 92% survival obtained for the cells cooled 7-times more rapidly in Table 1.

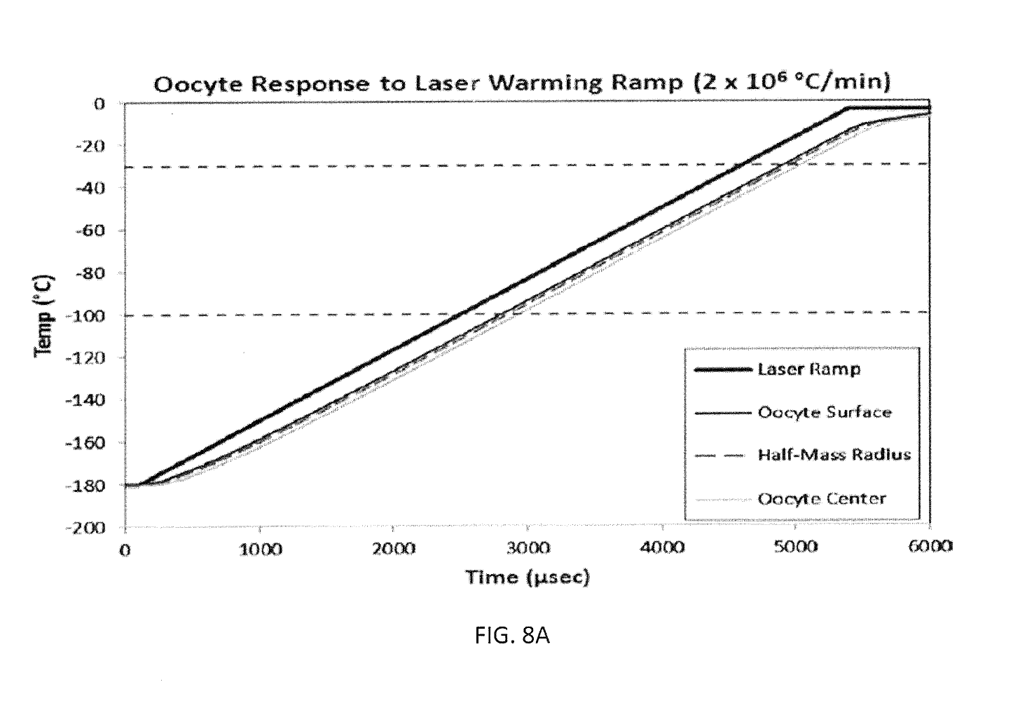

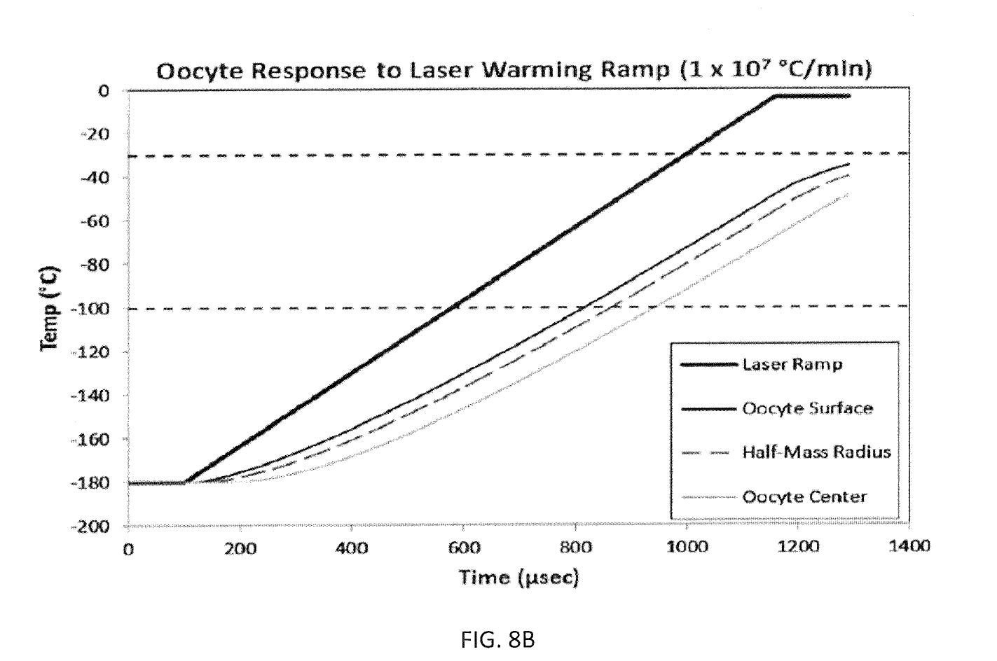

In employing laser-assisted ultra-rapid warming, it can be desirable that the cell or tissue be small or thin enough to respond without excessive lag to the energy provided by the laser. For example, if the India Ink particles are employed, they are restricted to the medium outside the cell, the warming of the cell has to occur by the conduction of heat from that medium to the cell interior. The larger the cell, the longer that path becomes and the more it can become the limiting factor in the maximum warming rate that can be attained for the cell. Also, the larger the cell, the greater might be differences in warming rate in different regions of the cell. However, the results of modeling described in FIGS. 8A and 8B below appear to show that no such differences are discernible at a warming rate of 10⁷° C./min in a cell with a diameter of 75 μm. Calculations suggest that a laser could warm cells and tissues with diameters or thicknesses of 750 μm as rapidly as 10⁶° C./min without these problems becoming crippling; i.e., 1/10^{th} the maximum rate used here.

### Example 3

### Further Considerations Regarding Ultra-Rapid Warming by Laser Pulse

The presently disclosed subject matter involves, in some aspects, warming frozen and/or vitrified samples at warming rates 10 to 100-fold higher than 10⁵° C./min, the rate currently attainable when thin plastic strip, such as a CRYOTOP® (Kitazato BioPharma Co. Ltd., Fuji, Japan) or similar cryopreservation devices, with an adhering small droplet of sample (e.g., an oocyte suspension) is transferred from liquid nitrogen (LN₂) into a room-temperature solution or warm water bath. Ultra-high warming rates, such as 10⁶ and 10⁷° C./min, can be obtained, however, for example, by laser heating.

To warm at 10⁶ and 10⁷° C./min, laser energy has to be delivered and absorbed in 10.6 and 1.06 msec, respectively (WR=ΔT/Δt, where ΔT is the temperature range and At is the time to traverse that range, which is equal to the duration of the laser pulse). ΔT can be derived as follows: When the CRYOTOP® is removed from LN₂, it is estimated that it takes about 0.1 sec for the residual liquid nitrogen to evaporate. Warming at 130° C./second then begins from contact with 23° C. air. See Mazur et al., Cryobiology 62 (2011), 1-7. The laser can fires an estimated 0.15 seconds later. Consequently, during this 0.15 seconds, the CRYOTOP® and sample have warmed an estimated 20° C. Thus, rounding off, −180° C. can be used as the starting temperature of the laser pulse. While air warming at about 10⁴° C./minute continues even after the laser pulse turns on, but its contribution to warming is only about 1/10^{th} to 1/1000^{th} of the laser pulse. The end point occurs at about −3.5° C., the melting point of 0.33× EAFS solutions. Thus, the value of ΔT is believed to be 176.5° C.

Calculations based on the masses and specific heats of the components (0.1 μl sample of oocytes in EAFS on a CRYOTOP®) show that it requires 0.037 joules to warm from −180° C. to −3.5° C. It has been reported that when 0.33× EAFS is cooled at 69,000° C./min, it freezes and does not vitrify. See Parades and Mazur, Cryobiology, 67 (2013), 386-390. Consequently, the present calculations were modeled to include 0.1 mg ice and 0.06 mg for the 1 mm portion of the polypropylene blade that is warmed from −180° C. to −3.5° C. by the laser pulse. Two-thirds of this energy is required to warm the ice in the sample and the remainder to warm the blade of the CRYOTOP®. There are usually five oocytes on a CRYOTOP®, but their total volume (0.002 μl) can be neglected, for it is only 1/50^{th} the volume of the droplet (0.1 μl). Because of the solutes in the sample, a small amount of melting begins at the eutectic point of the solution (about −60° C. for EAFS). It increases as warming progresses, and is complete at −3.5° C., the melting point of the sample. (The freezing point depression is 2 molal times −1.866° C./mole.) The energy required for melting (latent heat of fusion) is estimated as the energy to melt 0.1 μl (0.1 mg) of ice, which is 0.033 J. This is comparable to the energy required to warm the sample from −180° C. Thus the total energy required to warm the sample from −180° C. and melt it at −3.5° C. is 0.070 J.

In practice, laser energy is adjusted to just melt the samples as visualized immediately after the laser pulse through the 15× stereo microscope built into the laser. It is believed that it would be advantageous to stop just short of melting. However, it can be difficult to monitor such an end point. Laser settings to achieve melting can be determined or confirmed with several trial shots at the beginning of each day. Good consistency in survivals can be obtained with this procedure.

A representative laser employed according to the presently disclosed subject matter was a pulsed Nd:YAG laser emitting in the IR at 1064 nm manufactured by LaserStar Technologies (Riverside, R.I., United States of America), for example, the 990 Series iWeld 40 Joule Laser model. See FIG. 2. With some restrictions near the ends of the ranges, this model can deliver 0.1 to 40 joule pulses in 0.5 to 30 milliseconds with a beam diameter of 0.05 to 2 millimeter (mm). As this laser is generally used in welding operations by jewelers, it has a number of built-in safety features.

Of consideration is not only the energy emitted by the laser, but also the fraction of that radiant energy that is absorbed by the EAFS medium and the oocytes. The consideration here is that water only absorbs ˜2% of the 1064 nm IR. The approximately 2 molal modified EAFS solutions have a slightly higher absorption, estimated as bout 3.5% based on measurements of sample melting as a function of the ink concentration extrapolated to zero. Still, the the absorption of the samples is low. Thus, a material is added to the suspension that does absorb the laser wavelength and which is non toxic. An exemplary absorbing material is a suspension of carbon black, e.g., in the form of Higgins #44201 Waterproof Black India Drawing Ink (Higgins Inks, Chatpack, Inc., Leeds, Mass., United States of America). Its absorbance properties have been shown to approximate those of an ideal black body; namely, a body that absorbs radiation over a broad range of wavelengths. See Wagner et al., Sol. Energy 25 (1980), 549-554; and Madsen et al., Phys. Med. Biol., 37 (1992), 985-993.

Counter-intuitively, it can be desirable to keep the transmittance of the sample high (optical density low). In other words, the majority of the beam energy should desirably pass right through the sample. The reason is that, if the transmittance were low, the front part of the sample would receive most of the incident energy, and rearward portions would be shadowed. Keeping the transmittance high produces a relatively even deposition of energy throughout the depth of the sample. After initial studies, 80% transmission through the 0.1 μl sample was chosen as the target transmission percentage. This means the back or ‘exit’ side of the sample will receive 80% of the heating received by the front or ‘entrance’ side. On the basis of a droplet thickness of 0.3 mm and the measured Higgins ink absorptivity in 0.33× EAFS of 1.38%⁻¹ mm⁻¹ at 1064 nm, the ink concentration needed for sample heating was calculated to be about 0.25% using the Beer-Lambert Law. The amount is somewhat approximate, due to bottle to bottle variations in the absorptivity of the ink. An ink concentration of only about 2.5 parts in 1000 is not be expected to injure the oocytes, especially since the India Ink particles are far too large to pass through the zona pellucida of the oocyte and come in contact with the cell surface.

The 990 Series iWeld 40 Joule laser discussed above has a so-called ‘Soft Touch’ profile, which produces a more even power distribution across the beam profile than the standard Gaussian profile. This provides a more uniform heating of the sample and reduces the demands for accurate XY positioning of the sample. Consider a spatially uniform 2 mm diameter beam. The cross sectional area of the cryo sample is ˜0.6 mm×0.6 mm≅0.36 mm² with 80% transparency or 20% absorption, and the sample intercepts and absorbs a fraction of the beam energy equal to:

$$Ef = [ \frac{Area\_sample}{Area\_beam} ] * Sample\_absorption = 0.04$$

Thus, the sample absorbs 4% of the incident energy. Since the energy delivered by the laser exceeds 6 J per pulse in the regimes of interest, it can deposit as much as 0.24 J of energy in the sample. In other words, the available laser energy that could be deposited in the sample is about three times the 0.070 J needed to warm the sample from −180° C. and melt it at −3.5° C.

Having calculated the required laser power and knowing the area over which it is distributed, the potential for direct damage to the oocytes from the laser pulse can be addressed. Literature on optical tweezers demonstrates that laser intensities (watts/area) of as much as 150 times the maximum that we have used have no demonstrable effect on, for example, Chinese hamster ovary cells. See Liu et al., Biophys. J., 68 (1995), 2137-2144; and Zhang and Liu, J. R. Soc. Interface, 5 (2008), 671-690. Furthermore, as shown in Table 1, the laser powers sufficient to warm the oocytes at the maximum calculated rate still produce survivals of >90%. Thus, there is neither theoretical nor experimental evidence for oocyte damage from the laser beam itself.

A main cause of injury during the warming of oocytes is the recrystallization of intracellular ice. On both the basis of both experimental data with oocytes and on theory, recrystallization does not occur in oocytes below −100° C. nor above ˜−30° C. Hence, it is this temperature range over which the warming rate is expected to have major biological effects. The warming rate is determined by the laser power, the sample mass, and its thermal properties (heat capacity and heat of fusion). It is estimated that the laser power is constant to approximately 5%, and, of course, the sample mass is constant. The sample thermal properties are more complex. In this temperature range (−100 to ˜−30° C.), the specific heat of the target (sample and CRYOTOP®) rises somewhat with temperature. In ice, it is 0.43 cal/° C./g at −40° C. (see Dorsey, Properties of Ordinary Water-Substance, American Chemical Society Monograph Series, Vol. 81, Reinhold Publishing Co., New York, 1940) compared to 0.5 cal/° C./g at 0° C., a difference of only 14%. The specific heat of the polypropylene blade rises similarly with rising temperature. See Grebowicz et al., J. Polym. Symp., 71 (1984), 19-37. And, as the specific heat capacity of the sample rises, the warming rate diminishes (since more energy is required for a given temperature change). However, the effect on the warming rate is small compared to the 10 to 100-fold range in rates used according to the presently disclosed methods. A second factor that alters the thermal properties of the target is the melting which begins at the eutectic point of the EAFS solutions (approximately −60° C.). As the temperature rises, increasing portions of the laser energy go to melt the EAFS rather than warming it. This also slows down the warming rate over what it would otherwise be.

To summarize certain power and temperature issues, the ice crystallization events of interest to the presently disclosed subject matter are believed to occur between −100° C. and ˜−30° C. The sample starts at −196° C. in LN₂ and warms to about −180° C. in air. At that point, the laser fires and warms the sample to −3.5° C. and melts it. The sample then warms in air to room temperature. Assuming the laser pulse warms the sample from −180° C. to −3.5° C., laser pulse durations of about 10 and about 1 milliseconds yield warming rates (ΔT/Δt) of 1×10⁶ to 1×10⁷° C./min, 10 to 100 times faster than warming rates of previously reported methods.

However, two factors can make warming rates based on WR=ΔT/Δt where ΔT is the change in temperature from −180 to −3.5° C. and Δt is the duration of the laser pulse (controlled with the laser settings) an over-simplification of the actual warming rate experienced by the oocytes. One of these factors in this is that the warming rate inside the oocytes can be less than the laser-induced warming rate in the surrounding medium because of thermal lag. The second factor is that the warming rate above the eutectic point (˜−60° C.) is progressively slowed by the melting of an increasing fraction of the ice.

Since the cells and the EAFS media themselves absorb only an insignificant fraction of the incident laser energy, the presently disclosed method can involve suspending mouse oocytes in a dilute suspension of India ink particles in EAFS or diluted EAFS vitrification solutions. The ink particles are the primary absorber of the laser energy and are heated by it. This heat is then transmitted to the surrounding EAFS solution, and transmitted from there to the surface of the oocyte and then to its interior. To examine how long energy transfer takes and whether the warming rate of the oocyte differs from that of the external medium and/or varies in different regions inside the oocyte, a simple, finite element analysis of Fourier heat conduction was developed using Microsoft Excel. First, the entire system was taken to have the thermal properties of pure ice, with warming starting at −180° C., the temperature at which the laser pulse turns on. Absorption of the laser beam energy was assumed to be exclusively via the India Ink particles in the EAFS. The finite elements were assumed to be 2 μm thick spherical shells. The system was then broken down into three concentric regions. The outer one is a ‘sea’ of EAFS solution (and India Ink particles) far from the oocyte. This outer region was assumed to responds to the laser warming ramp (pulse) with a temperature given by T₁=−180+WR*t, where t is the length of time the laser pulse has been on.

Interior to the “sea” is a second region taken to be a shell of 0.3× EAFS and India Ink located between 100 μm and 47.5 μm from the center of the oocyte. The 47.5 μm radius lies at the outer surface of the zona pellucida of the extended oocyte (47.5 μm becomes 48 μm in the model because the model resolution is only 2 μm). The temperature at the 100 μm outer boundary of region II is set at the temperature of the EAFS ‘sea’. This boundary condition is believed to be a good approximation, as this second region has eight times the volume of the extended oocyte and thus provides a good thermal ‘boundary zone’ between the oocyte and the EAFS sea. Three thermal effects operate in this second region. Heat is being ‘added’ to it by the laser and from the “sea”, and heat is being removed from it by the cold oocyte. The change in temperature of an element in this region during one time step, δt, is given by:

T′=Tₒ+WR*δt+(1/cₚ*g)[(k*δt/δr)(A_{U}*δT_{U}−A_{L}*δT_{L})]

where:
T′ and Tₒ are the new and old element temperatures of the element being evaluated,
WR is the warming rate and WR*δt is the laser component of temperature change,
cₚ and k are the specific heat capacity and thermal conductivity of ice, taken to be:
cₚ=1.67 J/g/K and k=3.0 W/m/K, chosen at ˜−70° C., the middle of the temperature range of prime interest between −100 and −30° C.,
g is the mass of the spherical shell in question and δr is the finite element step size, 2 μm,
A_{U} and A_{L} are the upper (r greater) and lower (r lesser) surface areas of the adjacent shells to the one being evaluated,
δTu and δT_{L} are the differences in temperature between the upper shell and shell in question and similarly for δT_{L}.

The third region is that of the extended oocyte. This is the 47.5 μm region between the zona pellucida and the center of the oocyte. It is modeled with the same above equation except that there is no India Ink present; therefore, there is no direct laser warming, and as a consequence, we omit the term WR*δt.

This model was applied to theoretical warming rates of 2×10⁶ and 1×10⁷° C./min, corresponding to laser pulse durations of approximately 5 milliseconds and 1 millisecond, respectively. Some 13,000 time steps were used for each analysis. FIG. 8A shows the oocyte response for the warming rate of 2×10⁶ and FIG. 8B the response for the warming rate of 1×10⁷° C./min. The four curves in each figure depict the temperature-time relationships for the applied warming ramp, the surface of the extended oocyte, the half-mass radius, and the center of the oocyte. The half-mass radius is that radius at which half the oocyte mass is outside and half inside.

In FIGS. 8A and 8B, thermal lags can be observed between the oocyte and the medium and between regions in the oocyte. However, they arise below −100° C. and remain nearly constant over the temperature range of interest. Not surprisingly, they are greater when the warming rate is 1×10⁷° C./min than when it is 2×10⁶° C./min. Within the oocyte, the temperature lag between the surface of the oocyte and its center is four degrees Celsius with a warming rate of 2×10⁶° C./min and twenty degrees Celsius with a rate of 1×10⁷° C./min. While a gradient of 20° could produce mechanical damage, that appears not to be the case here, as indicated by several samples from Example 2 where that ultra-high warming rate yields survivals above 90%.

With regard to the actual warming rate the oocytes experience, when the applied rate is 2×10⁶° C./min, the warming rate in all regions of the oocyte is the same. See FIG. 8A. However, when the applied rate is 1×10⁷° C./min (see FIG. 8B), the warming rate at oocyte half mass radius is 15% less between −100 and −40° C. and 25% less between −100 and −30° C. Thus, it is less, but only 15% to 25% less.

One assumption in this modeling is that shell III extends 47.5 μm from the center of the oocyte to the outer surface of the zona pellucida in isotonic media. However, as pointed out above, it has been calculated that just before the initiation of vitrification, the volume of water in the oocytes in most of the 0.3× solutions used has decreased osmotically to approximately 13% of its isotonic value (V_{w}=isotonic osmolality/osmolality of the vitrification solution). As a result, the volume of the cell, V_{c}, has decreased to 29% of the isotonic value [V_{c}=(V_{w}+d)/1+d)], where d is the volume of the endogenous cell solids divided by the volume of water in the isotonic cell, and has a value of 0.22 in the mouse oocyte. See Mazur and Schneider, Cell Biophys., 8 (1986), 250-285. The volume of the shrunken oocyte is thus 29% of the isotonic cell volume of 221,000 μm³, which corresponds to a radius of 25 μm. That is close to the half-mass radius of 29.8 μm. Furthermore, the slope (WR) of the half-mass curve is nearly indistinguishable from the warming slopes of the two other oocyte regions plotted, even with the highest laser-induced warming rate of 1×10⁷° C./min.

Attempts have been reported to warm frozen living tissues rapidly by microwave heating. These efforts have been mostly stymied, however, by two facts. One is that water and ice have different microwave absorptivities. The other problem is that the microwave power is far from uniform in the chamber or cavity. The consequence is thermal runaways; i.e., situations where the water in a portion of the sample boils while other portions are still frozen. These problems do not arise in laser IR heating.

To assess the effects of warming versus melting on the computation of warming rate, an idealized sample of pure ice with a melting point of −3.5° C. can be considered. The laser pulse has to warm the sample from −180° C. to −3.5° C. (frozen) and then melt the sample isothermally at −3.5° C. In the first portion, all the absorbed laser energy goes to warm the ice and zero goes to melt it. The second portion is the opposite. All the energy goes to melt the ice and zero energy goes to warm it. Experimentally, At has been defined for the presently disclosed subject matter as the time between initiating the laser pulse and the time the sample is melted. But as shown earlier, the laser energies for these two processes are about equal. Consequently, the times have to be approximately equal, and the At applicable to the first portion is half of that used in the present equation. If At is halved, then the actual warming rates are twice those calculated by WR=ΔT/Δt. In practice the error is not this large because the sample is an aqueous solution of EAFS and not pure ice. Above the eutectic point of approximately −60° C., the laser energy begins both to warm the sample and to simultaneously melt it. As more and more of the absorbed energy is diverted to the melting of ice, the more the warming rate is slowed. This slowing of the warming somewhat compensates for the 2-fold increase in warming rate.

Summarizing the above, the true warming rates over the range of interest is likely higher than those calculated from the simple formula WR=ΔT/Δt , but they are probably less than twice as high because of the behavior of solutions during warming. At an uncorrected laser ramp warming rate of 1×10⁷° C./min, the oocytes warm about 25% more slowly; namely, 0.75×10⁷° C./min. However, there are no differences in warming rate within the oocyte. At an uncorrected warming rate of 2×10⁶° C./min, no differences in warming rates are detectable among any of the curves.

### Example 4

### Vitrification Without Permeating Cryoprotectants Followed by Ultra-Rapid Warming

The effects of vitrification in solutions without permeating cryoprotectants was further studied. Briefly, vitrification was initialed by transferring oocytes and embryos at 23° C. into three successive 100 μl drops of vitrification solutions composed of 0.72 (0×Std-1) or 1.0 molal (0×Std-2) sucrose and 0.0062 molal Ficoll PM 70 (70,000 daltons) dissolved in PB1. During the ensuing 1 minute and 45 seconds, 5 oocytes or embryos in a 0.1 μl drop of the medium were placed on a CRYOTOP® (Kitazato BioPharma Co., Ltd., Fuji, Japan) and 15 seconds later rapidly cooled to −196° C. Warming and post-warming procedures as described in Example 1 were carried out. See Jin and Mazur, Scientific Reports, 5:9271; DOI: 10.1038/srep09271.

The morphological and functional survivals of oocytes vitrified in either 0.72 molal sucrose (0×Std-1) or 1.0 molal sucrose (0×Std-2), warmed at 1.2×10⁵° C./min (no laser) or 1×10⁷° C./min are summarized in Table 4. Each solution in Table 4 also contained 0.15 molal salt and 0.0062 molal Ficoll. The warming rate of 1×10⁷° C. per minute was achieved with a laser pulse. The percentages that are morphologically normal are the numbers in the fourth column per number of oocytes in the third column. The numbers and percentages that are functionally viable are in the fifth and sixth columns. After warming the oocytes were exposed to freshly collected sperm diluted to a concentration of 3×10⁶/ml with Cook Fertilization medium.

As can be observed from Table 4, at the lower warming rate, there were no morphological or functional survivors. However, when a laser pulse was used to warm the samples 100 times faster, the morphological survivals ranged from 77 to 89% and the 2-cell functional survivals from 78 to 96% of the morphological survival. With laser warming, 61% also developed to expanded blastocysts. The morphological survivals of oocytes vitrified in 1.0 molal sucrose solutions and warmed by laser were slightly, but non-significantly higher than those vitrified in 0.72 molal sucrose.

TABLE 4
Survival of Mouse Oocytes after Vitrification in 0.72 or 1.0 Molal Sucrose.

| | | | N (% | | | | | |
|---|---|---|---|---|---|---|---|---|
| Vitrifi- | Warming | | morpho- | | | | N (% | |
| cation | Rate | # egg | logically | | N (% | | expanded | |
| Solution | (° C./min) | (# runs) | Normal | | 2-cell) | | blastocyst) | |
| 0xStd-1: | — | 40 (8) | 40 | (100) | 35 | (88 ± 3.7) | 31 | (78 ± 4.5) |
| no vitrific. | | | | | | | | |
| 0xStd-1: | 1.2 × 10⁵ | 20 (4) | 0 | (0) | 0 | (0) | 0 | (0) |
| with vitrific. | | | | | | | | |
| 0xStd-1: | 1 × 10⁷ | 35 (7) | 27 | (77 ± 5.2) | 21 | (78 ± 6.5) | 19 | (70 ± 8.0) |
| with vitrific. | | | | | | | | |
| 0xStd-2: | — | 60 (12) | 60 | (100) | 58 | (97 ± 2.2) | 43 | (72 ± 5.2) |
| no vitrific. | | | | | | | | |
| ** | — | 30 (6) | 30 | (100) | 26 | (87 ± 6.7) | 24 | (80 ± 7.3) |
| 0xStd-2: | 1.2 × 10⁵ | 20 (4) | 0 | (0) | 0 | (0) | 0 | (0) |
| with vitrific. | | | | | | | | |
| ** | 1.2 × 10⁵ | 20 (4) | 0 | (0) | 0 | (0) | 0 | (0) |
| 0xStd-2: | 1 × 10⁷ | 57 (12) | 44 | (77 ± 3.5) | 40 | (91 ± 4.2) | 25 | (57 ± 4.3) |
| with vitrific. | | | | | | | | |
| ** | 1 × 10⁷ | 35 (7) | 31 | (89 ± 4.0) | 30 | (96 ± 3.6) | 17 | (55 ± 7.3) |

** the oocytes were first suspended in 0xStd-1 for 2 minutes and then transferred to 0xStd-2 for 1 minute prior to vitrification.

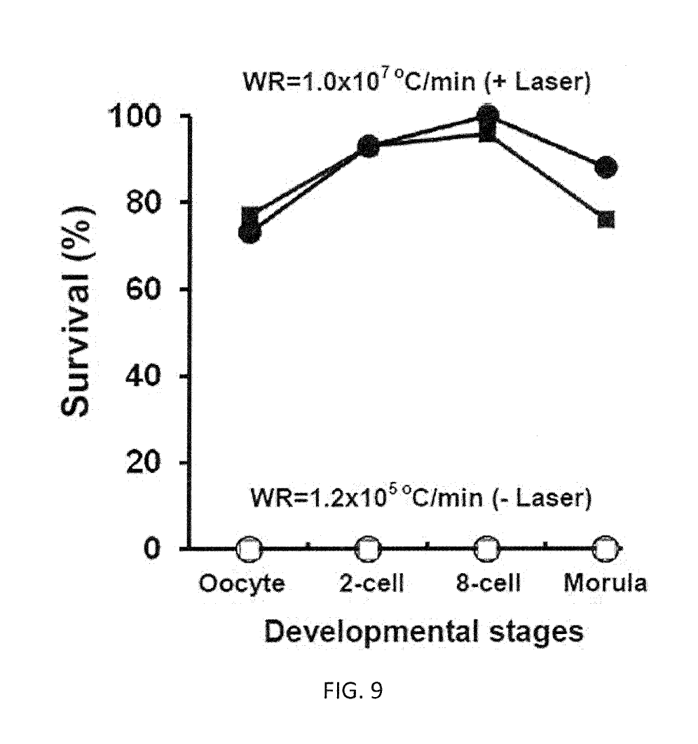

Table 5 shows the morphological and functional survivals of 2-cell and 8-cell embryos and morulae. Again, none of the embryos survived either morphologically or functionally when warmed at the lower rate. High percentages of embryos survived after warming at the higher rate. The morphological and functional survivals of the morulae were slightly lower. FIG. 9 summarizes the results of morphological and functional survival of oocytes and various stage embryos with and without laser warming.

TABLE 5
Morphological and Functional Survival of 2 and 8 Cell Embryos
and Morulae After Vitrification in 0.72 Molal Sucrose.

| | | Number | N (% | | | |
|---|---|---|---|---|---|---|
| Vitrifi- | | of embryos | morpho- | | N (% | |
| cation | Warming | (number | logically | | of expanded | |
| solution | Rate | of runs) | normal) | | Blastocyst) | |
| 2-cell | | 30 (6) | 30 | (100) | 29 | (97 ± 3.3) |
| embryos | | | | | | |
| None | 1.2 × 10⁵ | 20 (4) | 0 | (0) | 0 | (0) |
| (control) | | | | | | |
| 0xStd-1 | 1.0 × 10⁷ | 29 (6) | 27 | (93 ± 4.9) | 25 | (93 ± 4.2) |
| Un- | | 25 (5) | 25 | (100) | 24 | (96 ± 4.0) |
| compacted | | | | | | |
| 8-cell | | | | | | |
| embryos | | | | | | |
| None | 1.2 × 10⁵ | 20 (4) | 0 | (0) | 0 | (0) |
| (control) | | | | | | |
| 0XStd-1 | 1.0 × 10⁷ | 25 (5) | 24 | (96 ± 4.0) | 24 | (100) |
| Compacted | | 35 (7) | 35 | (100) | 33 | (94 ± 4.0) |
| Morulae | | | | | | |
| None | 1.2 × 10⁵ | 20 (4) | 0 | (0) | 0 | (0) |
| (control) | | | | | | |
| 0XStd-1 | 1.0 × 10⁷ | 34 (7) | 26 | (76 ± 2.8) | 23 | (88 ± 5.7) |

As described above, the maximum survival (approximately 90%) of oocytes was obtained when the total molality of the EAFS solution was around 2 molal. Molalities are moles of solutes per kg water. The reciprocal is related to the mass concentration of water, which can be expressed in several ways, three of which are displayed in Table 6, i.e., the mass of water (Ww) in the oocyte after two minutes of equilibration in the vitrification solution (VS) as a fraction of the amount in the isotonic cell, the mass of water in the oocyte after two minutes of equilibration relative to the mass of cell solids, and the mass of water in the oocyte relative to the total mass of the cell after two minutes of equilibration in the VS.

Survivals of mouse oocytes after vitrification in 0.3×EAFS solution and laser warming as a function of the fraction of cell water are shown in Table 6. The volume fraction of the isotonic zona-free mouse oocyte that is occupied by cell solids is 0.18. Protein constitutes 71% of the dry mass and typical proteins have a density of 1.36 g/cm³. Thus if this is assumed to be the density of all the cell solids, the mass of cell solids relative to the volume of an isotonic oocyte is 0.18×1.36 g/cm³ or 0.233 g/g. Accordingly, the relative mass of cell solids for each sample is believed to be 0.233. The survivals are taken from Table 1 and based on morphology and osmotic integrity. Functional survivals based on percentages of normal morphology ooyctes developing into 2-cell embryos after IVF were also determined for the 0.33×-4 and 0.33×-5 solutions. They were 83% and 86%, respectively. The volume of water in the cell (Vw) is provided as a fraction of the initial isotonic water volume (approximately equal to the ratio of the water masses) after 2 minutes osmotic equilibration with the external medium assuming the van't Hoff relation Mᵢₛₒ/Nₑₓₜ−0.3 (molality of the external solution +0.15 to account for the fact that NaCl forms 2 ions).

TABLE 6
Survival as a Function of the Fraction of Cell Water at the Time of Vitrification.

| | | | | | % Survival | Survival |
|---|---|---|---|---|---|---|
| | | Vw₁ | Mass of cell | Mass of cell | with laser | without Laser |
| | Total | (~Ww) | water after 2 | water/Total | warming | warming |
| | external | After | min./mass | mass after | (1 × 10⁷° | (1 × 10⁵° |
| Solution | molality | 2 min. | of solids | 2 min. | C./min.) | C./min.) |
| 1xStd | 7.38 | 0.040 | 0.178 | | | 91.7 ± 6.3 |
| 0.33xStd F0 | 1.72 | 0.160 | 0.689 | 0.408 | 49 ± 8.9 | 0 |
| 0.33xStd | 1.72 | 0.160 | 0.689 | 0.408 | 66 ± 6.0 | 24 ± 5.0 |
| 0.33x-1 F0 | 2.28 | 0.123 | 0.530 | 0.346 | 86 ± 4.8 | 36 ± 10 |
| 0.33x-1 | 2.28 | 0.123 | 0.530 | 0.346 | 96 ± 2.7 | 28 ± 8.0 |
| 0.33x-2 | 2.29 | 0.123 | 0.528 | 0.345 | 74 ± 6.8 | 30 ± 9.3 |
| 0.33x-3 | 2.57 | 0.110 | 0.473 | 0.321 | 71 ± 7.3 | 0 |
| 0.33x-4 | 2.07 | 0.135 | 0.580 | 0.367 | 92 ± 3.3 | 26 ± 7.2 |
| 0.33x-5 | 1.82 | 0.152 | 0.654 | 0.395 | 86 ± 4.7 | 70 ± 6.5 |
| 0.33x-6 | 1.73 | 0.160 | 0.685 | 0.406 | 84 ± 7.5 | 76 ± 7.5 |
| 0.33x-7 | 1.57 | 0.174 | 0.749 | 0.428 | 80 ± 3.8 | 67 ± 8.4 |

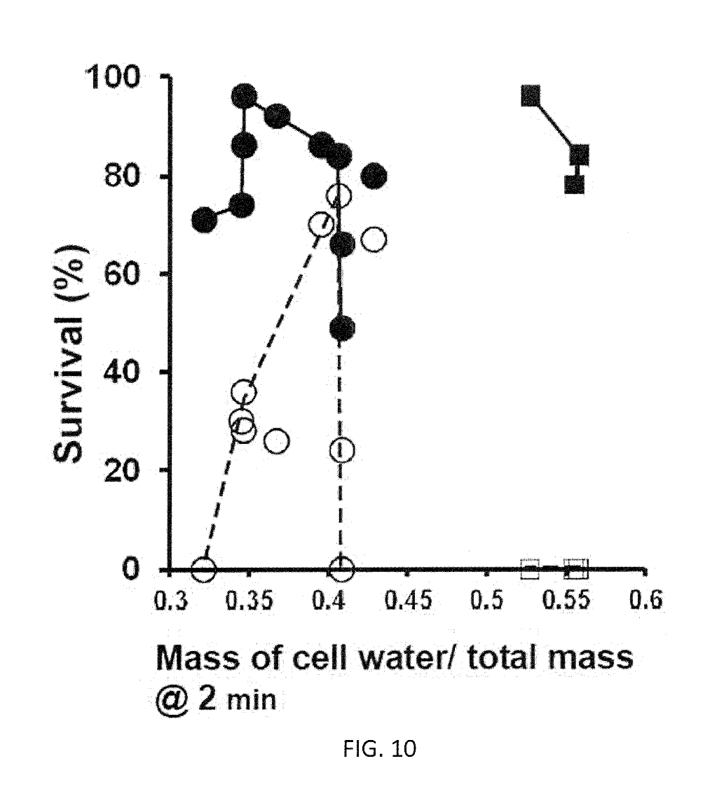

Survivals shown in Table 6 are also plotted in FIG. 10. All three measures of cell water content yield similarly shaped curves. The maximum survival of 96% occurred when the oocytes contained 0.35 g water/total mass of the shrunken cells. However, survival remained 80% or higher even when the water content was as high as 0.43 g water/g cells. Survival decreased with further increases in water content. Decreases in survival also occurred with decreases in water content. When samples were warmed 100 times more slowly without the laser (open dots and dashed line in FIG. 10), the inverted “V” of the curve became sharper. Maximum survival of 76% occurred with a water ratio of 0.41 g water/g, but then dropped to zero. It also dropped when the cell water content fell below 0.40 g water/g cells.

Various measures of water mobility in yeast cells as a function of their water content (e.g., expressed as a percent of original water content and the ratio of the mass of cell water to the total mass of the osmotically dehydrated cell) have been studied previously. See Koga et al., Biophysical J., 6, 665-674 (1966). In the previous studies, it was determined that water mobility decreases more or less linearly when yeast cell water content drops below 0.3 g/g total mass and the cell water becomes totally immobilized when its concentration falls to 0.11 to 0.24 g/g. The presently presented data shows that the survival of mouse oocytes in diluted EAFS rises to a maximum of 96% as the water content is lowered from 0.43 to 0.35 g/g of the osmotically shrunken cells. Thus, if mouse oocytes behave like yeast, these values suggest a correlation between the range of water contents that affect water mobility and the range of water contents that affect survival after vitrification. Without being bound to any one theory, the connection between the two ranges could be the rapidity at which lethal recrystallization of ice occurs as a function of cell water content. The more water the cell contains, the faster the warming has to be to avoid recrystallization.

However, Table 7, below, and the right side of FIG. 10 (i.e., the squares) show different results for mouse oocytes vitrified in a VS that contains 0.72 or 1 molal sucrose, but neither permeating solute (i.e., EG or acetamide) from the VS solutions of Table 6. Survivals are based on the percentages of morphologically normal oocytes developing to 2-cell embryos after IVF. Morphological survivals were 77% and 83% in 0.72 and 1.0 molal sucrose, respectively. The solutions contained 0.72 or 1.0 molal sucrose plus 0.15 molal PB1 salts and 0.0013 or 0.0062 molal Ficoll. When these cells are warmed via laser (i.e., ultra-rapid warming), close to 90% survive (FIG. 10, filled squares), even using a comparatively water-rich VS medium containing 0.53 g water/g total cell mass. Furthermore, irrespective of water content, all the oocytes are killed (FIG. 10, open squares) when they are warmed 100 times more slowly in the absence of a laser pulse.

TABLE 7
Survival of Oocytes vitrified in 0.72 or 1.0 Molal Sucrose + Isotonic PB1 +
Ficoll as a Function of the Fraction of Cell Water at the Time of Vitrification.

| | | | | | % Survival | Survival |
|---|---|---|---|---|---|---|
| | | Vw₁ | Mass of cell | Mass of cell | with laser | without Laser |
| | Total | (~Ww) | water after 2 | water/Total | warming | warming |
| | external | After | min./mass | mass after | (1 × 10⁷° | (1 × 10⁵° |
| Solution | molality | 2 min. | of solids | 2 min. | C./min.) | C./min.) |
| 0xStd-1 | 0.88 | 0.291 | 1.25 | 0.555 | 78 ± 6.5 | 0 |
| 0xStd-1a | 0.87 | 0.294 | 1.26 | 0.558 | 84 ± 3.5 | 0 |
| 0xStd-2 | 1.156 | 0.260 | 1.12 | 0.527 | 96 ± 3.6 | 0 |

Overall, the present results indicate that, contrary to standard belief, the ability to survive vitrification to −196° C. and subsequent warming is more dependent upon the oocyte being dehydrated to a particular water content prior to vitrification rather than on the type or concentration of cryoprotectants. Survival is also dependent upon the rate of warming. Without being bound to any one theory, this seems to suggest that the rate of recrystallization of intracellular ice is sensitive to residual intracellular water content after vitrification.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for warming a sample comprising a cell or tissue, the method comprising:
(a) providing a sample comprising a cell or tissue in need of warming, wherein the sample further comprises a medium; and
(b) heating the sample at a warming rate of at least about 1×10⁶ degrees Celsius (° C.) per minute, whereby the cell or tissue survives after warming.

2. The method of claim 1, wherein the cell or tissue is dehydrated.

3. The method of claim 1, wherein the medium is a vitrification medium.

4. The method of claim 1, wherein the medium has a molality of from about 2 to about 7.

5. The method of claim 4, wherein the molality is about 2.

6. The method of claim 1, wherein the warming rate is at least about 1×10⁷° C. per minute.

7. The method of claim 1, wherein the medium comprises one or more solutes and the one or more solutes do not permeate the cell or tissue.

8. The method of claim 1, wherein the heating is accomplished by exposing the sample to a laser.

9. The method of claim 1, wherein the medium comprises a component that absorbs at a wavelength emitted by the laser.

10. The method of claim 1, wherein the component comprises carbon black particles and the wavelength of the laser is about 1064 nm.

11. The method of claim 1, wherein the cell or tissue is selected from the group consisting of an oocyte, an embryo, a sperm cell, an islet of Langerhans, an ovary cell, an ovary slice, a Drosophila embryo, a zebrafish embryo, a zebrafish stage II oocyte, a zebrafish stage III oocyte, a marine mollusk, a cornea, a cornea cell, and a marine echinoderm.

12. The method of claim 1, wherein the cell or tissue has a thickness or diameter of about 500 microns or smaller.

13. The method of claim 1, wherein providing a sample comprising a cell or tissue in need of warming comprises providing a sample wherein the sample is frozen and/or vitrified at a cooling rate of about 10,000° C. per minute or more.

14. A method for increasing the functional survival of a cell or tissue upon warming, the method comprising:
(a) providing a sample comprising a cell or tissue in need of warming, wherein the sample further comprises a medium; and
(b) heating the sample at a warming rate that increases the functional survival of the cell or tissue as compared to a cell or tissue in a sample that is not heated at the warming rate.

15. The method of claim 14, wherein the cell or tissue is dehydrated.

16. The method of claim 14, wherein the warming rate is at least about 1×10⁶ degrees Celsius (° C.) per minute.

17. The method of claim 14, wherein the medium is a vitrification medium.

18. The method of claim 14, wherein the medium has a molality ranging from about 2 to about 7.

19. The method of claim 18, wherein the molality is about 2.

20. The method of claim 14, wherein the warming rate is at least about 1×10⁷ degrees Celsius (° C.) per minute.

21. The method of claim 14, wherein the medium comprises one or more solutes and the one or more solutes do not permeate the cell or tissue.

22. The method of claim 14, wherein the heating is accomplished by exposing the sample to a laser.

23. The method of claim 22, wherein the medium includes a component that absorbs at a wavelength emitted by the laser.

24. The method of claim 23, wherein the component comprises carbon black particles and the wavelength of the laser is 1064 nm.

25. The method of claim 14, wherein the cell or tissue is selected from the group consisting of an oocyte, an embryo, a sperm cell, an islet of Langerhans, an ovary cell, an ovary slice, a Drosophila embryo, a zebrafish embryo, a zebrafish stage II oocyte, a zebrafish stage III oocyte, a marine mollusk, a cornea, a cornea cell, and a marine echinoderm.

26. The method of claim 14, wherein the cell or tissue has a thickness or diameter of about 500 microns or smaller.

27. The method of claim 14, wherein the sample is frozen and/or vitrified at a cooling rate of about 10,000° C. per minute or more.

28. A jig for a system for the rapid cooling and warming of a sample comprising a cell or tissue, wherein the sample further comprises a medium, the jig comprising:
(a) a holder adapted for movement between a first position and a second position;
(b) a shaft connected to the holder, the shaft having a first end and a second end, wherein the first end connects the shaft to the holder and wherein the second end of the shaft is adapted to receive a sample comprising a cell or tissue, wherein the sample further comprises a medium;
(c) a trigger adapted for activation when the holder is moved from the first position to the second position; and
(d) a switch operable to activate a heating source when the trigger is activated.

29. The jig of claim 28, wherein the trigger further comprises a cover operable to isolate a sample from a cooling source upon movement of the holder from the first position to the second position.

30. The jig of claim 29, wherein the cover is adapted for movement between a first cover position and a second cover position and is operably connected to the trigger such that the trigger actuates movement of the cover between the first cover position and the second cover position.

31. A system for the rapid cooling and warming of a sample comprising a cell or tissue, wherein the sample further comprises a medium, the system comprising:
(a) a jig comprising (i) a holder adapted for movement between a first position and a second position; (ii) a shaft connected to the holder, the shaft having a first end and a second end, wherein the first end connects the shaft to the holder and wherein the second end of the shaft is adapted to receive a sample comprising a cell or tissue, wherein the sample further comprises a medium; (iii) a trigger adapted for activation when the holder is moved from the first position to the second position; and (iv) a switch operable to activate a heating source when the trigger is activated;
(b) a heating source; and
(c) a cooling source;
wherein the heating and cooling sources are operably arranged with respect to the jig such that the sample can be contacted by the cooling source at the first position of the holder of the jig and the sample can be contacted by the heating source at the second position of the holder of jig.

32. The system of claim 31, wherein the heating source is a laser.

33. The system of claim 32, wherein the laser has a wavelength of 1064 nm.

34. The system of claim 31, wherein the cooling source is a reservoir adapted to receive a cooling medium.

35. The system of claim 34, wherein the cooling medium is liquid nitrogen.

36. The system of claim 31, wherein the cooling source further comprises a cover adapted for movement between a first cover position and a second cover position, wherein the cover is operably connected to the trigger wherein the trigger actuates movement of the cover between the first cover position and the second cover position.
